(19) United States
(12) Patent Application Publication
(10) Pub. No.: US 2023/0134280 A1
(43) Pub. Date: May 4, 2023

(54) CATALYSTS FOR THE FORMATION OF POLYURETHANES

(71) Applicant: MOMENTIVE PERFORMANCE MATERIALS INC., Waterford, NY (US)

(72) Inventors: Gnuni KARAPETYAN, Cologne (DE); Alberto Giovanni MELLE, Geneva (CH); Roger Christopher CLARK, Vienna, WV (US)

(21) Appl. No.: 17/907,869

(22) PCT Filed: Mar. 3, 2020
(86) PCT No.: PCT/US2020/020784

§ 371 Date: Aug. 29, 2022

(51) Int. Cl. C08G 18/18; C08G 18/48; C08G 18/08

(52) U.S. Cl. CPC C08G 18/1833; C08G 18/4829; C08G 18/0866; C08G 18/14; C08G 2101/00

(57) ABSTRACT

The invention relates to novel urethane or carbamate compounds which can act as a catalyst for the reaction of at least one isocyanate compound with at least one isocyanate-reactive compound, in particular for the manufacture of polyisocyanate polyaddition products, such as polyurethanes, in particular, for the manufacture of polyurethane (PU) foams, where they exhibit superior blowing performance.

The present invention relates to novel urethane or carbamate and urea compounds which are obtained by the reaction of an isocyanate compound with at least one isocyanate-reactive compound, said compounds being useful as a catalyst, a process for the manufacture of said compounds, the use of said compounds as a catalyst, in particular, as a catalyst for the reaction of at least one isocyanate compound with at least one isocyanate-reactive compound, in particular for the manufacture of polyisocyanate polyaddition products, such as polyurethanes, in particular, for the manufacture of water blown polyurethane (PU) foams, where they exhibit superior blowing performance.

### Technical Problem

Polyurethane foams are produced by reacting a polyisocyanate (or prepolymer made thereof) with compounds containing two or more active hydrogens (chain extenders, polyether polyols, polyester polyols, polyether amines and others), generally in the presence of blowing agent (chemical blowing agents as water etc. and physical blowing agents like pentane, cyclopentane, halohydrocarbons etc.), catalysts (tertiary amines, metalorganic derivatives of tin, bismuth, zinc and others), silicone-based surfactants and other auxiliary agents. Two major reactions are promoted by the catalysts among the reactants during the preparation of water blown polyurethane foams:
The reaction of the isocyanate-reactive compounds, such as polyols, with the isocyanates resulting in an increase of the polymer's molecular weight, which leads to the building of viscosity and gel strength, which reaction is referred to as gelling reaction.
The reaction of water with the isocyanates resulting in the generation of CO₂ gas which acts as a blowing agent, which reaction is referred to as blowing reaction.

Tertiary amines are well-known PU catalysts. They do have varying degrees of activity in promoting the gelling reaction. This is particularly true when the polyol has high inherent reactivity. In some formulations, the amine catalyst may be the only catalyst used. While organotin catalysts promote the gelling reaction, amine catalysts primarily affect the blowing reaction.

Most polyurethane foams emit volatile organic compounds. These emissions can be composed of, for example, contaminations present in raw materials, catalysts, degradation products or unreacted volatile starting materials or other additives. Amine emissions from polyurethane foam became a major topic of discussion particularly in car interior applications, in furniture or mattresses and the market is therefore increasingly demanding low-emission foams. The automotive industry in particular requires significant reduction of volatile organic compounds (VOC) and condensable compounds (fogging or FOG) in foams. An evaluation of VOC and FOG profiles of PU foams can be conducted by VDA 278 test. One of the main components emitting from flexible molded foams is the amine catalyst.

A reduction of amine emissions can be achieved amongst others by a) introduction of reactive hydroxyl or amino group to the molecule of the tertiary amine moiety enabling them to be linked to the polymer network, or by b) using tertiary amines having a very low vapor pressure. It is known that reactive amines degrade some fatigue properties such as humid aging compression set. In addition, reactive amines promote undesired chain termination thereby reducing the amount of the potent and agile amine catalytic moieties. Thus, the development of efficient polyurethane catalysts with low emission profile is one of the important targets of modern polyurethane industry.

U.S. Pat. No. 6,423,756 B1 describes tertiary amino derived IPDI based bis-carbamates as PU catalyst. The specific reactive tertiary amines, which are described in the patent application are based on dimethylaminoethoxyethanol, dimethylaminoethanol, bis(dimethylaminopropyl)amino-2-propanol. WO 2020011343 A1 describes the use of IPDI derived bis carbamates of bicyclic tertiary amines.

Despite the attempts made in the prior art there is still a need for catalysts compositions that are nonreactive, do not link to the polymer network but possess low emission performance.

The present invention describes new compounds, that can be used as catalysts, fulfilling the aforementioned requirements. Surprisingly, it was found that despite the higher molecular weight, the new molecules are very efficient and more differentiated blow catalysts as many other known catalysts.

In accordance with the present invention there is thus provided a compound obtained by the reaction of an isocyanate compound with at least one isocyanate-reactive compound of the formula (I):

(R)ₐ—X (I)

wherein

R is selected from R¹ and R², wherein

R¹ is selected from the group consisting of R³, R⁴, R⁵, R⁶, R¹⁴ and R¹⁶, where
R³ represents a hydrocarbyl group comprising at least two tertiary amino groups and at least one ether (—O—) group,
R⁴ represents a hydrocarbyl group comprising at least one monocyclic heterocyclic group,
R⁵ represents a group of the formula:

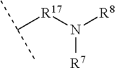

(the dotted line indicates the binding site to X)
wherein R¹⁷ represents an aliphatic hydrocarbyl group having at least three carbon atoms, and R⁷ and R⁸ each represent a linear or branched aliphatic hydrocarbyl residue, which optionally may be substituted by one or more tertiary amino groups, and may optionally contain one or more ether (—O—) groups,
R⁶ represents a group of the formula:

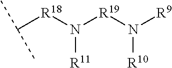

(the dotted line indicates the binding site to X)
wherein R¹⁸ represents an aliphatic hydrocarbyl group having at least two carbon atoms, R¹⁹ represents an aliphatic hydrocarbyl group having at least three carbon atoms, and R⁹ to R¹¹ each independently represent a linear or branched aliphatic hydrocarbyl residue,
R¹⁴ represents a group of the formula:

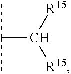

(the dotted line indicates the binding site to X)
wherein R¹⁵ each independently our selected from a hydrocarbyl group, comprising at least one tertiary amino group, and optionally comprises one or more ether (—O—) groups, and
R¹⁶ represents an aromatic group substituted by at least two hydrocarbyl groups, each comprising at least one tertiary amino group,

R² represents a hydrocarbyl group, preferably an aliphatic saturated hydrocarbyl group having up to 10 carbon atoms, still more preferably an alkyl group of up to 10 carbon atoms, or hydrogen,

a is 2 or 3, and

X is selected from the group consisting of O, S, or N,

with the provisos that the compounds comprise at least one group R¹ as defined above and at least one group R being R² being hydrogen and that R¹ can represent only one group R⁵, or salts thereof, and mixtures thereof.

Accordingly, in case X represents O or S, a is 2, and in case X represents N, a is 3. In order to be isocyanate-reactive the compounds of formula (I) must have at least one hydrogen atom bound to X (R² being hydrogen). X is preferably O or N. In case X is N, preferably there are two hydrogen atoms bound to N, and one group R¹, that is the isocyanate reactive compound has a primary amino group and is of the formula R¹—NH₂. The compound of formula R¹R²NH, wherein R² represents hydrocarbyl group, is less preferred. In case, X is O or S the compounds are accordingly of formula R¹—X—H, that is in particular hydroxy compounds of the formula R¹—OH and mercapto compounds of the formula R¹—SH. So basically, the compounds of formula (I) comprise any of the compounds of formulas R¹—NH₂, R¹R²NH, wherein R² represents hydrocarbyl group, and R¹XH, wherein R¹ is as defined above. The isocyanate-reactive compounds of the formula (I) usually apart from the isocyanate-reactive functional groups —OH, —SH, ═NH or —NH₂, do not comprise any further isocyanate-reactive functional groups, that is they are usually monofunctional with respect to the reaction with the isocyanate groups of the isocyanate compounds.

Exemplifications of such isocyanate-reactive compounds of formula (I) are for example selected from the following compounds:

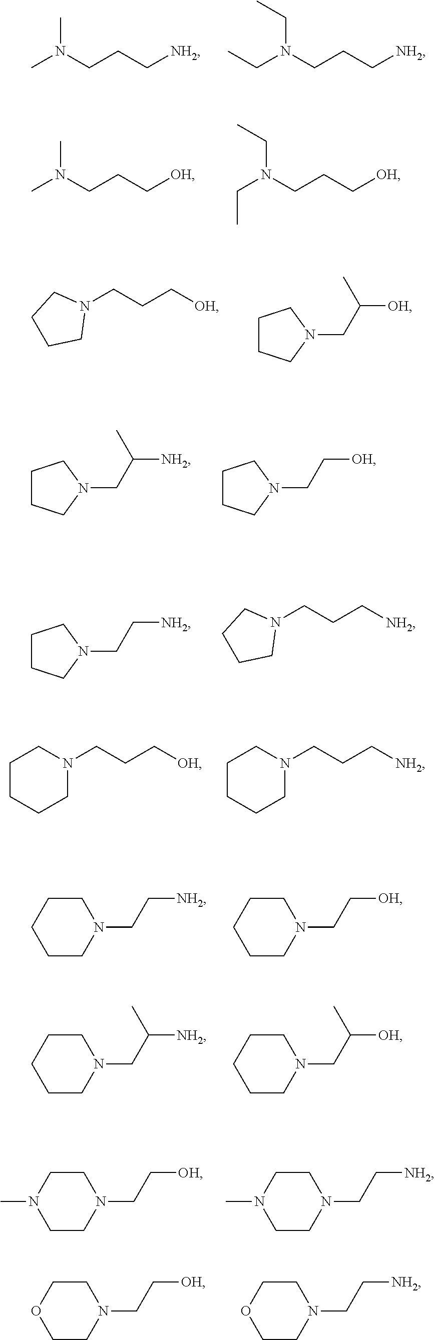

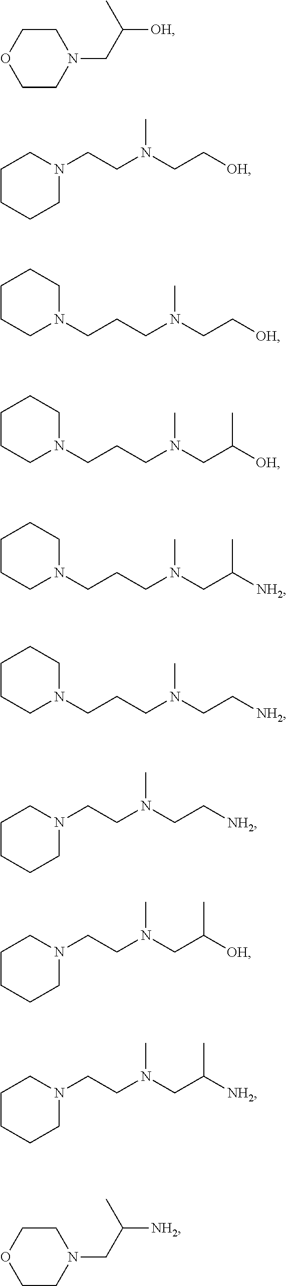

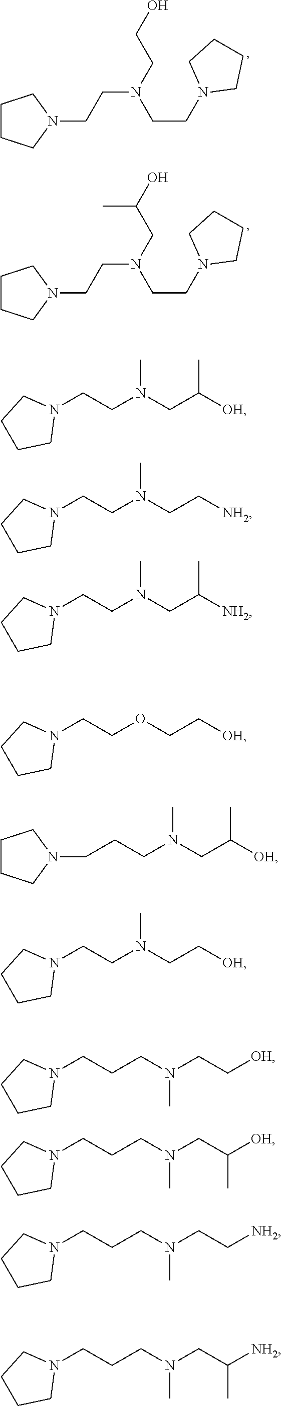

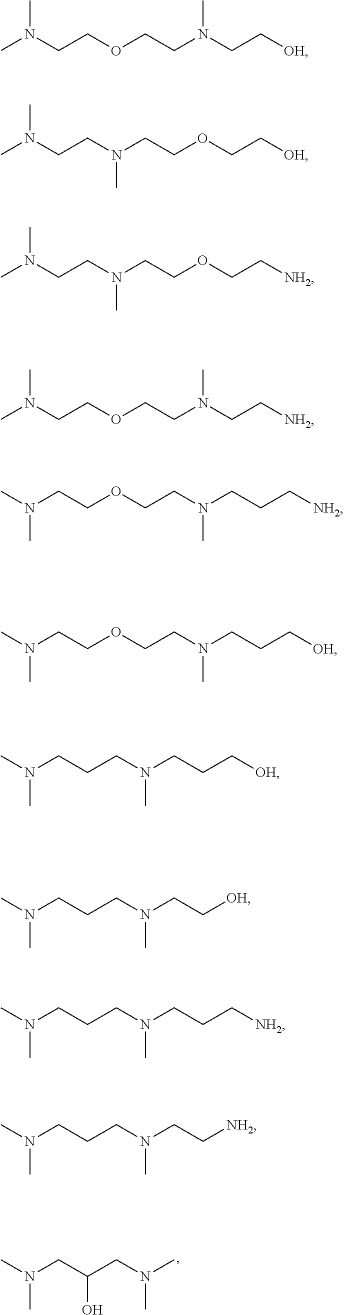

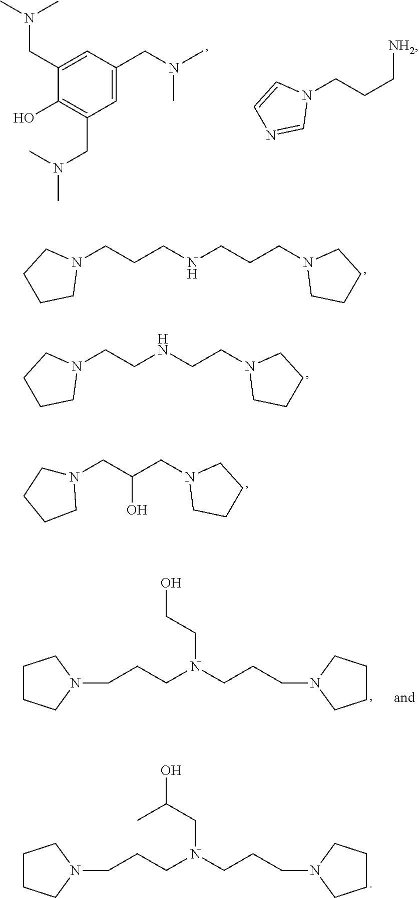

Particularly preferred compounds according to the invention are the reaction products of these isocyanate reactive compounds with isophorone diisocyanate (IPDI) and hexamethylene-1,6-diisocyanate (HDI), most preferred with isophorone diisocyanate (IPDI).

Such compounds include in particular and most preferred the compounds where the two isocyanate groups of the diisocyanates are reacted but may also include the compounds where only one isocyanate group has reacted and all molar ratios in between the two as exemplified for isophorone diisocyanate as follows:

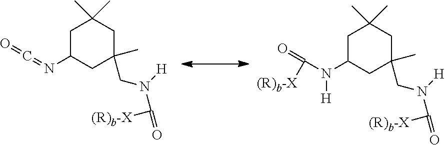

wherein R is as defined above, and b depending on whether X is S or O, or N, is 1 or 2. In a particular, preferred embodiment of the invention R¹ in formula (I) is selected from the group consisting of R³, that is, a hydrocarbyl group comprising at least two tertiary amino groups and at least one ether (—O—) group. The hydrocarbyl group is preferably a saturated aliphatic hydrocarbyl group for example an alkyl group having up to 25 carbon atoms which comprises at least one tertiary amino group:

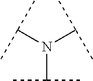

where all binding sites of the nitrogen atom (as indicated by the dotted lines) are bound to aliphatic hydrocarbyl residues.

Particularly preferred compounds according to the invention R¹ in formula (I) is selected from the group consisting of R³ selected from the group consisting of saturated aliphatic hydrocarbyl groups having up to 20 preferably, up to 15 carbon atoms, comprising at least two tertiary amino groups and at least one ether (—O—) group. In such preferred compounds R¹ in formula (I) is suitably selected from the group consisting of R³ selected from the following formula:

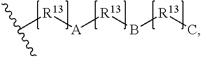

(wherein the wavy line represents the bonding site to X)

wherein the groups R¹³ are independently selected from a divalent linear, branched or cyclic hydrocarbyl groups, and two of A, B, C represent tertiary amino groups (for A and B selected from —N(R¹²)— and for C selected from —N(R¹²)₂ where R¹² is an organic group, preferably aliphatic hydrocarbyl group having up to 15 carbon atoms, preferably an alkyl group having up to 6 carbon atoms) and one of A, B, C represents an ether group (which for A and B is selected from —O— and for C selected from —OR¹², wherein R¹² is as defined before.

In particularly preferred compounds according to the invention R¹ in formula (I) is selected from the group consisting of R³ selected from the following formula:

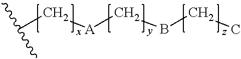

(wherein the wavy line represents the bonding site to X)

wherein x, y, and z are integers of 2 to 6, preferably 2 or 3, and wherein A, B and C are as defined before. Isocyanate-reactive compounds according to the invention, wherein R¹ in formula (I) is selected from the group consisting of R³ can be exemplified by the following formulas:

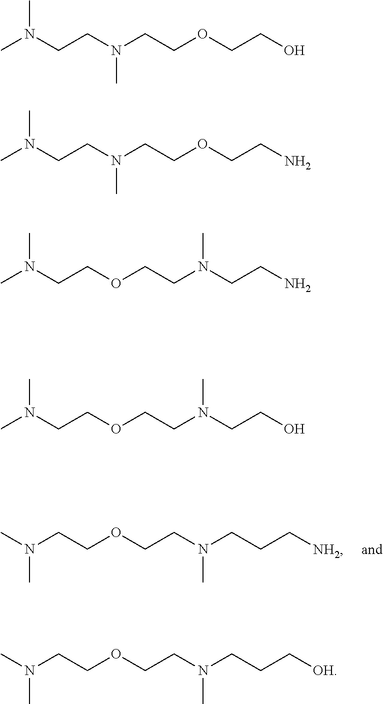

In such exemplified compounds X represents O or N, and R² represents hydrogen.

Particularly preferred isocyanate reactive compounds, wherein R¹ is selected from the group consisting of R³ are:

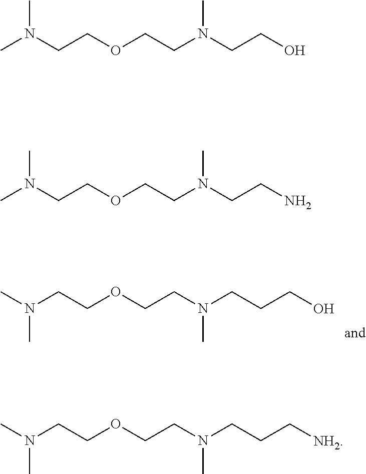

In a further preferred embodiment, R¹ in formula (I) is selected from the group consisting of R⁴, that is, R¹ represents a hydrocarbyl group, comprising at least one monocyclic heterocyclic group, preferably R¹=R⁴=an aliphatic hydrocarbyl group having up to 20 carbon atoms, which is substituted by at least one monocyclic heterocyclic group.

In particularly preferred isocyanate-reactive compounds, R¹ in formula (I) is selected from the group consisting of R⁴, which is a saturated linear or branched hydrocarbyl group having up to 10 carbon atoms, which may contain up to three heteroatoms, such as N or O, which may be optionally substituted by one or more hydroxy groups, and which hydrocarbyl group is substituted by at least one monocyclic heterocyclic group, selected from saturated or unsaturated or aromatic optionally substituted 5 to 6-membered heterocyclic rings having preferably one or two heteroatoms selected from N, O and S, preferably N and O, more preferably N. Particularly preferred monocyclic heterocyclic groups in R⁴ are selected from the group consisting of pyrrolidinyl, piperidyl, 4-alkylpiperazin-1-yl, imidazolyl, and morpholin-4-yl, preferably imidazolyl, more preferably R⁴ is imidazol-1-yl.

Particularly preferred isocyanate-reactive compounds wherein R¹ in formula (I) is selected from the group consisting of R⁴ are selected e.g. from:

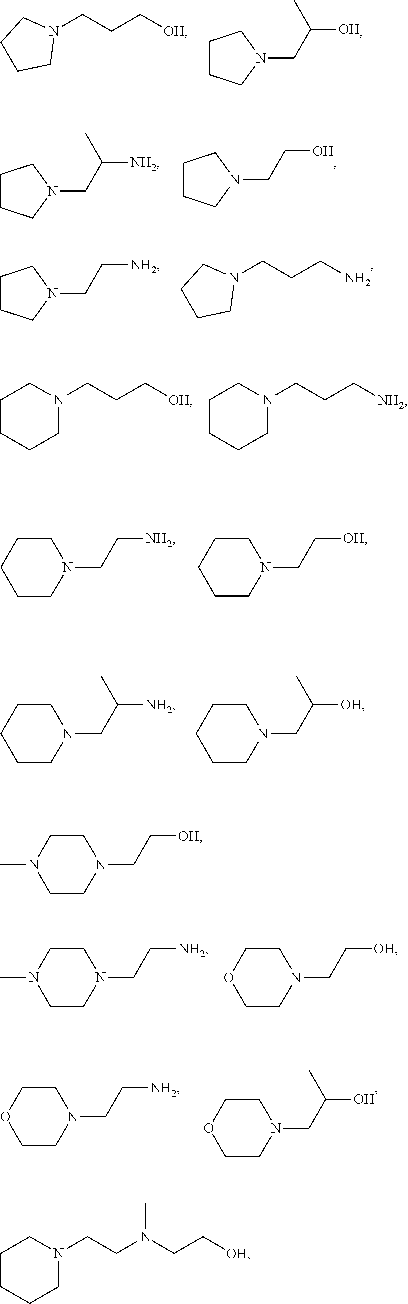

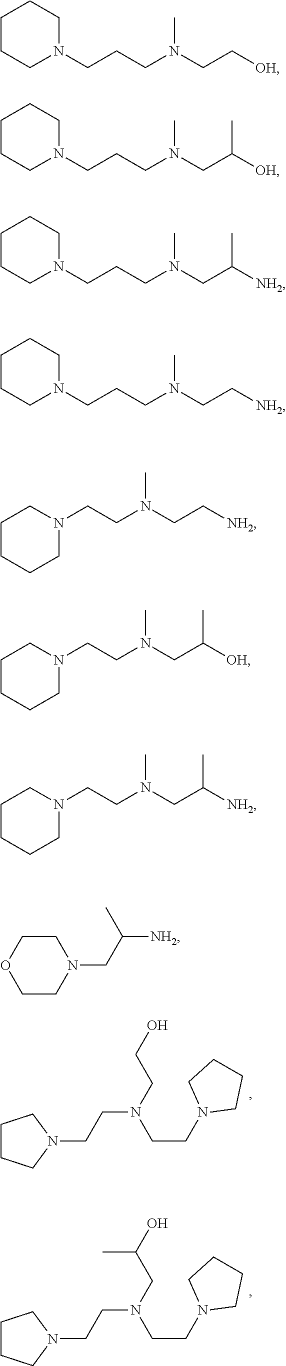

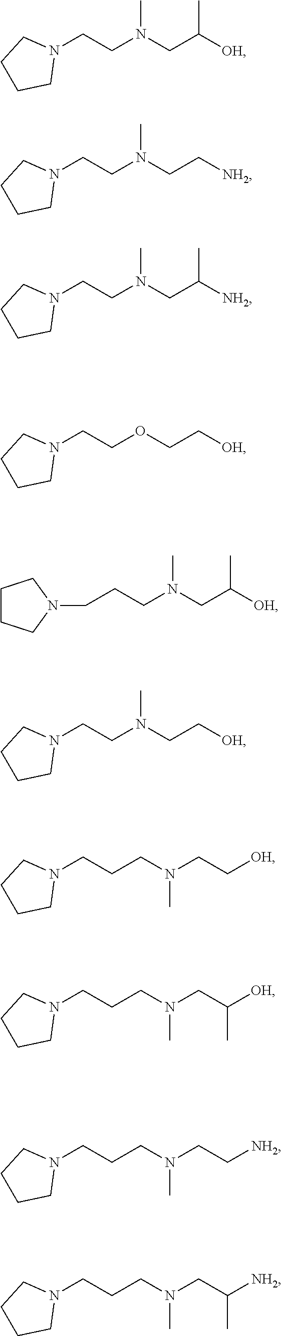

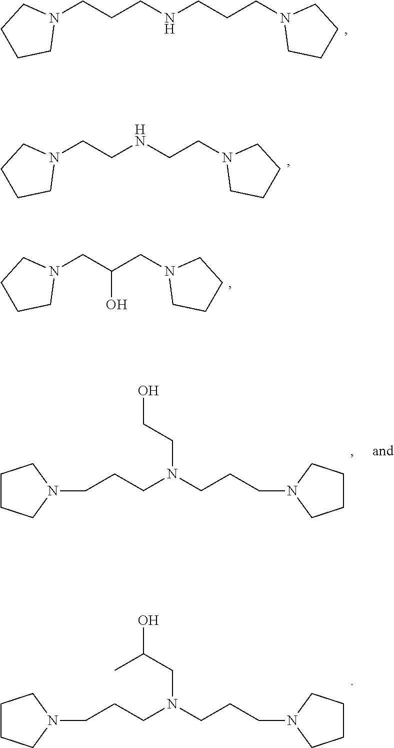 [SMILES: C1CCN(CCCNCCCN2CCCC2)C1 ; C1CCN(CCNCCN2CCCC2)C1 ; OC(CN1CCCC1)CN1CCCC1 ; OCCN(CCCN1CCCC1)CCCN1CCCC1 ; CC(O)CN(CCCN1CCCC1)CCCN1CCCC1]

In a preferred embodiment R¹ in formula (I) of the isocyanate-reactive compounds is selected from the group consisting of R⁵ and R⁶, wherein

R⁵ represents a group of the formula:

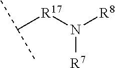

(the dotted line indicates the binding site to X)

wherein R¹⁷ represents an aliphatic preferably saturated hydrocarbyl group having at least three carbon atoms and preferably at most 10 more preferably at most 6 carbon atoms, and R⁷ and R⁸ each represent a linear or branched aliphatic preferably a saturated hydrocarbyl residue having preferably at most 10 preferably at most 6 carbon atoms, which optionally may be substituted by one or more tertiary amino groups, preferably di(C1-C6)alkylamino groups, and may optionally contain one or more ether (—O—) groups,

R⁶ represents a group of the formula:

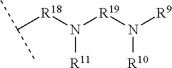

wherein R represents an aliphatic preferably saturated hydrocarbyl group having at least two carbon atoms and preferably having at most 10, more preferably at most 6 carbon atoms, R¹⁹ represents an aliphatic preferably saturated hydrocarbyl group having at least three carbon atoms and preferably at most 10, more preferably at most 6 carbon atoms, and R⁹ to R¹¹ each independently represent a linear or branched aliphatic preferably saturated hydrocarbyl residue having preferably 1 to 10 carbon atoms, more preferably 1 to 6 carbon atoms, still more preferably 1 carbon atom (methyl),

In a further preferred embodiment R¹ in formula (I) of the isocyanate-reactive compounds is selected from the group consisting of R⁵ and R⁶, wherein

R⁵ represents a group of the formula:

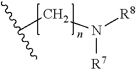

wherein n represents an integer of ≥3, preferably 3 to 10, more preferably 3 to 6, and even more preferred 3, and R⁷ and R⁸ each represent a linear or branched aliphatic preferably saturated hydrocarbyl residue having preferably 1 to 10 carbon atoms, more preferably 1 to 6 carbon atoms and even more preferred 1 carbon atom (methyl), which optionally may be substituted by one or more tertiary amino groups, preferably di(C1-C6)alkylamino groups, and may optionally contain one or more ether (—O—) groups, and

R⁶ represents a group of the formula:

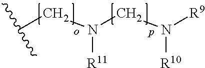

wherein o represents an integer of ≥2, preferably 2 to 10, more preferably 2 to 6 and even more preferred 2 of 3, p represents an integer of ≥3, preferably 3 to 10, more preferably 3 to 6 an even more preferred 3, and R⁹ to R¹¹ each represent a linear or branched aliphatic hydrocarbyl residue.

In a further preferred embodiment R¹ in formula (I) of the isocyanate-reactive compounds is selected from the group consisting of R⁵ and R⁶, wherein

R⁵ represents a group of the formula:

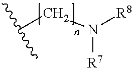

wherein n represents an integer of 3 to 6, and R⁷ and R⁸ each represent a linear or branched alkyl group with up to 6 carbon atoms, preferably with 1 carbon atom (methyl), and

R⁶ represents a group of the formula:

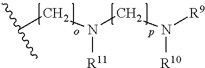

wherein o represents an integer of 2 to 6, preferably 2 of 3, p represents an integer of 3 to 6, preferably of 3, and R⁹ to R¹¹ each represent a linear or branched alkyl group with up to 6 carbon atoms, preferably methyl.

In a further preferred embodiment R¹ in formula (I) of the isocyanate-reactive compounds is selected from the group consisting of R⁵ and R⁶, and the isocyanate-reactive compound is selected from the group consisting of:

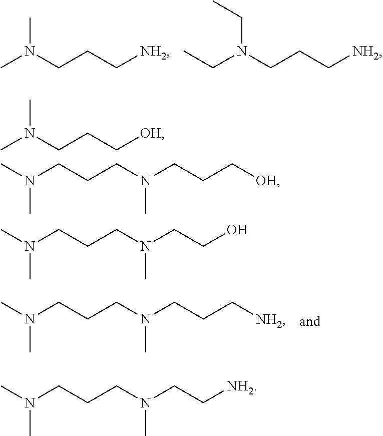

In a further preferred embodiment R in formula (I) of the isocyanate-reactive compounds is selected from the group consisting of R¹⁴ or R¹⁶:

R¹⁴ represents a group of the formula:

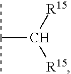

wherein R each independently our selected from a hydrocarbyl group, preferably an aliphatic, preferably saturated hydrocarbyl group having preferably up to 10, even more preferably up to 6 carbon atoms comprising at least one tertiary amino group (in particular, a dialkylamino group, such as a dimethylamino group), and optionally comprises one or more ether (—O—) groups, and

R¹⁶ represents an aromatic group, such as a C6-C10 aromatic group, preferably phenyl group substituted by at least two hydrocarbyl, preferably saturated aliphatic groups having up to preferably 6 carbon atoms, which each comprises at least one tertiary amino group (in particular, a dialkylamino group, such as a dimethylamino group).

Preferred isocyanate-reactive compounds, wherein R¹ in formula (I) is selected from the group consisting of R¹⁴ or R¹⁶, are selected from:

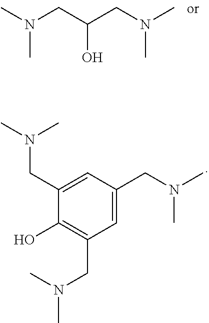

The isocyanate-reactive compounds which are reacted with the isocyanate compound are selected in particular from the group of the formulas (la) and (Ib):

R¹—OH (Ia),

R¹—NH—R² (Ib), and

R¹—NH—R¹ (Ic),

wherein R¹ and R² are each as defined above. In case R² in formula (Ib) is hydrogen, primary amines of the formula R¹—NH₂ (Id) result, wherein R¹ is as defined above. Preferred according to the invention are in particular the compound of formula (Ia) and (Id), wherein R¹ is preferably selected from R³.

Preferably the isocyanate compounds used to prepare the compounds of the invention are selected from monoisocyanates and polyisocyanates (having two or more isocyanate groups), and mixtures thereof. Mixtures may include mixtures of monoisocyanates, mixtures of polyisocyanates, or mixtures of one or more monoisocyanates and one or more polyisocyanates. Preferred are polyisocyanates.

Monoisocyanates can be selected for example from aliphatic or aromatic isocyanates, such as octadecylisocyanate; octylisocyanate; butyl and t-butylisocyanate; cyclohexyl isocyanate; adamantyl isocyanate; ethylisocyanatoacetate; ethoxycarbonylisocyanate; phenylisocyanate; alphamethylbenzyl isocyanate; 2-phenylcyclopropyl isocyanate; 2-ethylphenylisocyanate; benzylisocyanate; meta and para-tolylisocyanate; 2-, 3-, or 4-nitrophenylisocyanates; 2-ethoxyphenyl isocyanate; 3-methoxyphenyl isocyanate; 4-methoxyphenyl isocyanate; ethyl 4-isocyanatobenzoate; 2,6-dimethylphenylisocyanate; 1-naphythylisocyanate; and (naphthyl) ethylisocyanates.

Polyisocyanate can be selected for example from aliphatic or aromatic polyisocyanates, preferably aliphatic polyisocyanates, which are preferably selected from the group consisting of isophorone diisocyanate (IPDI); toluene diisocyanate (TDI); diphenylmethane-2,4′-diisocyanate (2,4′-MDI); diphenylmethane-4,4′-diisocyanate (4,4′-MDI); hydrogenated diphenylmethane-4,4′-diisocyanate (H.12 MDI); tetra-methyl xylene diisocyanate (TMXDI); hexamethylene-1,6-diisocyanate (HDI); napthylene-1,5-diisocyanate; 3,3′-dimethoxy-4,4′-biphenyldiisocyanate; 3,3′-dimethyl-4,4′-bimethyl-4,4′-biphenyldiisocyanate; phenylene diisocyanate; 4,4′-biphenyldiisocyanate; trimethylhexamethylene diisocyanate; tetramethylene xylene diisocyanate; 4,4′-methylene-bis (2,6-diethylphenyl isocyanate); 1,12-diisocyanatododecane; 1,5-diisocyanato-2-methylpentane; 1,4-diisocyanatobutane; and cyclohexylene diisocyanate and its isomers or and derivatives thereof, such as biurets, isocyanurates, allophanates, and oligomers thereof, for example, uretidione dimers of HDI; trimethylolpropane trimer of TDI, isocyanurate trimers of TDI, HDI, IPDI; biuret trimers of TDI, HDI, or IPDI; and polyisocyanates as mentioned before, where the isocyanate groups are partially reacted with at least one isocyanate-reactive compound which does not have a group R¹, preferably selected from OH-, NH-, and NH₂-functional optionally substituted hydrocarbons, which may contain one or more heteroatoms, such as alcohols, like methanol, tert.-butanol, isopropanol, sec.-butanol, OH-functional monoglycol ether, OH-functional diglycol ether etc.

Three- or higher-valent aliphatic polyisocyanates include, in particular, biurets, allophanates, urethanes, isocyanurates and higher oligomers of diisocyanates of in particular hexamethylene diisocyanate (HDI), 1-isocyanato-3,3,5-trimethyl-5-isocyanatomethyl-cyclohexane (IPDI or isophorone diisocyanate) and/or bis(isocyanatocyclohexyl)-methane etc. Specific examples of such polyisocyanates include e.g.:
the biuret of hexamethylene diisocyanate and oligomers thereof, e.g.:

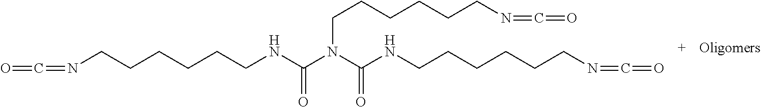 [SMILES: O=C=NCCCCCCNC(=O)N(CCCCCCN=C=O)C(=O)NCCCCCCN=C=O]

commercially available e.g. as Desmodur® 100;
the isocyanurate trimer of hexamethylene diisocyanate, e.g.:

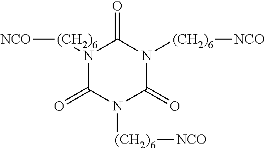

commercially available e.g. Desmodur® N3300, or higher oligomers thereof such as pentamers:

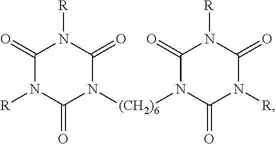

or asymmetric trimers such as:

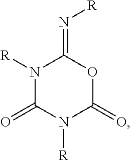

where R is an isocyanate containing aliphatic residue resulting from HDI, or 4,4′-methylenebis(cyclohexyl isocyanate) (HMDI or hydrogenated MDI);
The isocyanurate trimer of isophorone diisocyanate, e.g.:

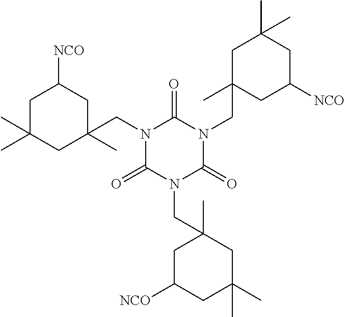

commercially available e.g. as Desmodur® Z4470 or Tolonate IDT 70B.

Further polyisocyanates can be prepared for example from polyhydroxyfunctional compounds or polymers with preferably at least equimolar amount of diisocyanates such as HDI, IPDI or HMDI to form corresponding polyisocyanates.

Preferably the isocyanate compound is a polyisocyanate selected from isophorone diisocyanate (IPDI), hexamethylene diisocyanate (HDI), and derivatives derived from IPDI and/or HDI such as biurets, isocyanurates, allophanates, and oligomers thereof, preferably isophorone diisocyanate (IPDI) or hexamethylene-1,6-diisocyanate (HDI isophorone diisocyanate (IPDI) and hexamethylene-1,6-diisocyanate (HDI), and the uretidione dimers; the trimethylolpropane trimers, the isocyanurate trimers and the biuret trimers thereof, preferably selected from isophorone diisocyanate (IPDI) and hexamethylene-1,6-diisocyanate (HDI). More preferred isocyanate compounds include aliphatic polyisocyanates, preferably, aliphatic diisocyanate compounds, in particular hexamethylene-1,6-diisocyanate (HDI) and isophorone diisocyanate (IPDI). The most preferred isocyanate compound is isophorone diisocyanate (IPDI).

In the compounds of the invention the isocyanate groups of the polyisocyanates are completely or partially reacted, preferably they are completely reacted with the isocyanate-reactive compound of the formula (I). That is to say that for example in a diisocyanate compound it is possible that only one of the two isocyanate groups react with the isocyanate reactive compounds by virtue of selecting a suitable molar ratio of NCO/isocyanate reactive functional group (such as —OH, —SH, —NH₂ or —NHR (with R being an hydrocarbyl group) of 1:1. Accordingly if the number of isocyanate groups in the polyisocyanates is designated as v, then the number of moles of the isocyanate reactive groups in the isocyanate reactive compounds per isocyanate groups in the polyisocyanate compound can be v or less than v.

It is also possible to react a molar excess of the isocyanate reactive compounds (based on the isocyanate groups in the isocyanate compounds), whereby a mixture of compounds according to the invention and the isocyanate reactive compounds is prepared. Such compositions of the compounds of the invention are also included in the scope of the present invention and they will be described in more detail below.

Depending on the isocyanate reactive compounds the compounds according to the invention can be selected from compounds of the carbamate compounds of formula (II):

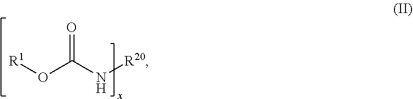

wherein R¹ is as defined above, x is 1 to 6 and R²⁰ is one- to six-valent optionally substituted hydrocarbyl group that optionally contains one or more heteroatoms and which is bound to the nitrogen atom of the urethane group by a carbon atom, and the urea compounds of the formula and (III):

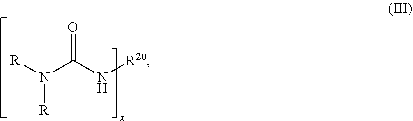

wherein one R is R¹ as defined above, and the other R is selected from R¹ or R² as defined above, and x and R²⁰ are as defined above, wherein R²⁰ is bound to the nitrogen atom of the urea group by a carbon atom.

The group R²⁰ results from the isocyanate compound, including the mono isocyanate compounds and the polyisocyanate compounds as described above. It is thus preferably a saturated, unsaturated or aromatic hydrocarbyl group having preferably up to 40 carbon atoms, preferably up to 30 carbon atoms, more preferably up to 20 carbon atoms, which may comprise one or more hetero atoms, and still more preferably it is an aliphatic saturated hydrocarbyl group having up to 20 carbon atoms such as those regarding from HDI or IPDI. Specific examples of the compounds according to the present invention are selected for example from the HDI or IPDI reaction products of the above mentioned isocyanate reactive compounds of formula (I), in particular such compounds where both isocyanate groups have reacted with the isocyanate reactive compounds of formula (I).

Particularly preferred compounds according to the invention are selected from

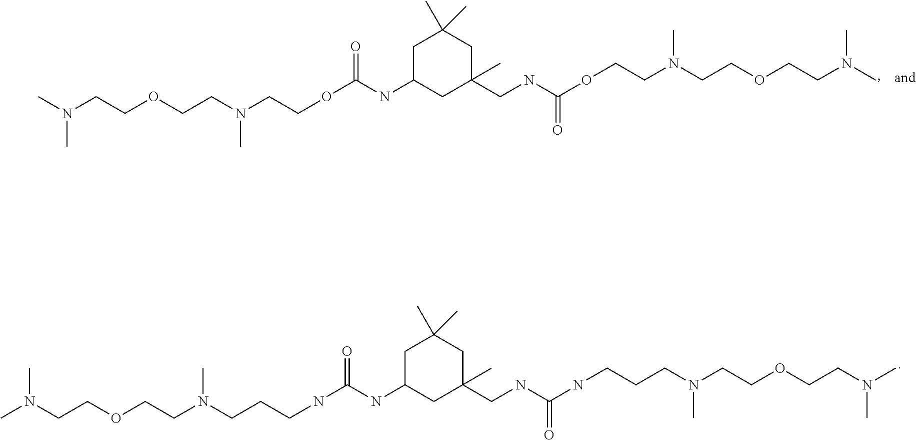

The present invention further relates to a process for the manufacture of the compounds according to the invention, which process comprises reacting at least one isocyanate compound and at least one at least one isocyanate-reactive compound of the formula (I) as defined above. Preferably such process is carried out at a temperature of about 20-140° C., more preferable about 40-120° C., and most preferable about 60-100° C., optionally in the presence of one or more diluents and one or more catalysts. Non-reactive diluents/solvents may include e.g. aprotic organic solvents (ethyl acetate, acetone, acetonitrile, ketones, haloalkanes, diglyme, dioxane, ethers—diethylether, methyl butyl ether, tetrahydrofuran, alkanes, dimethyl sulfoxide (DMSO), dimethylformamide (DMF), toluene, benzene, xylene and their analogues or mixtures thereof) which can be used to dissolve or melt the components prior mixing them. Preferably the reaction is carried out under vigorous stirring, and the isocyanate compound is added under inert gas atmosphere to the isocyanate reactive compound or vice versa. The addition of the isocyanate compound is carried out slowly in a continuous manner or in portions in a discontinuous manner. In view of the exothermic reaction the temperature increases. Generally, it is preferred to perform the reaction under inert atmosphere (nitrogen, argon, or others) to exclude moisture. After reaction completion, the diluents/solvents can be partially or fully removed to afford the final compounds, their mixtures or concentrated solutions thereof.

The present invention further relates to a composition comprising one or more compounds according to the invention, which further comprises at least one diluent. Such diluents may serve in particular to reduce the viscosity of the composition. Reactive diluents may include in particular such compounds that react in a polyurethane of polyurea formation reaction where the compounds of the invention act as a catalyst.

Diluents can include in particular an excess of the isocyanate-reactive compounds of formula (I) or any other isocyanate-reactive compound or non-isocyanate-reactive compound, that is, a diluent that does not react with isocyanates. In case of using isocyanate-reactive compounds of formula (I) in particular a molar excess of such isocyanate-reactive compounds is used, which then serves then as a diluent of the composition according to the invention. With respect to such isocyanate-reactive compounds of formula (I) it can be referred to the preferred embodiments described before. It is also possible to add any diluent including any other isocyanate-reactive compounds different from formula (I) after the reaction of the at least one isocyanate compound for formula (I) and at least one isocyanate-reactive compound. Such isocyanate-reactive compounds different from formula (I) may include various types of amines or alcohols, and may also include known amine catalysts for polyurethane formation as explained below.

Non-reactive diluents/solvents may include in particular dialkyl sulfoxides such as dimethyl sulfoxide, diethyl sulfoxide, diisobutyl sulfoxide, and the like; N,N-dialkylalkanolamides such as N,N-dimethylformamide, N,N-dimethylacetamide, N,N-diethylacetamide, etc.; phosphonates such as O,O-dimethyl, O,O-diethyl, O,O-diisopropyl methylphosphonates, O,O-di(2-chloroethyl) vinylphosphonate, etc.; aromatic solvents such as toluene, xylene, benzene, etc.; ether solvents such as diethyl ether, dioxane, diglyme, etc.; tetramethylenesulfone, 1-methyl-2-pyrrolidone, trialkyl phosphates such as trimethyl and triethyl phosphates, acetonitrile, and the like, and organic carbonates like di-methyl-carbonate, ethylene-carbonate, propylene-carbonate, or combinations thereof. The diluent/solvent may be used with a co-solvent such as a fatty acid, a vegetable oil, or a combination thereof. Preferred solvents include glycols such as ethane-1,2-diol, propane-1,2-diol, propane-1,3-diol, butane-1,4-diol, propane-1,2,3-triol, diethylene glycol, dipropylene glycol, triethylene glycol, tetraethylene glycol, tripropylene glycol, 2-methyl-1,3-propanediol, 2-methyl-2,4-pentandiol. Those diluents/solvents can be used as mixtures or cosolvents together with amines.

A particular preferred diluent can be water, which may act as a blowing agent in the subsequent polyurethane or polyurea foam formation reaction, where the inventive compounds act as catalysts.

In a further preferred embodiment of the composition according to the invention, it can optionally comprise one or more additional amines or amine catalysts for the formation of polyisocyanate polyaddition products, such as amines different from the isocyanate-reactive compounds. For example such catalysts include alkyl amines such as bis(2-dimethylaminoethyl)ether, N,N-dimethylcyclohexylamine, N,N,N′,N′,N″-pentamethyldiethylenetriamine, N,N,N′,N′,N″-pentamethyldipropylenetriamine triethylenediamine, ethanol amines, such as 2-aminoethanol, diethanolamine, triethanolamine, N-methyldiethanolamine, N,N-dimethylethanolamine, N,N-diethylethanolamine, N-methylethanolamine, N-ethylethanolamine, diisopropylamine, bis(2-hydroxypropyl)amine, 2-[2-(dimethylamino)ethoxy]ethanol, 1-[bis[3-(dimethylamino)propyl]amino]-2-propanol, 3-dimethylamino-N,N-dimethylpropionamide, N,N′-dimorpholinodiethyl ether, N,N′-dimethylpiperazine, N-methylmorpholine, N-ethylmorpholine, 2-{[2-(dimethylamino)ethyl]methylamino}ethanol, 3,3′-iminobis(N,N-dimethylpropylamine), 3-(dimethylamino)-1-propylamine, 3-(diethylamino)-1-propanol, 1-(3-hydroxypropyl)pyrrolidine, 1-(2-hydroxypropyl)pyrrolidine, 1-(2-hydroxyethyl)pyrrolidine, 1-(2-hydroxyethyl)piperidine, 1-(3-hydroxypropyl)piperidine, 1-(2-hydroxypropyl)piperidine, 1-(3-aminopropyl)pyrrolidine, 1-(2-aminoethyl)pyrrolidine, 1-(3-aminopropyl)piperidine, 1-(2-aminoethyl)piperidine, 1-(1-pyrolidineyl)-2-propanamine, 1-(piperidin-1-yl)propan 2-amine, N-methoxyethylmorpholine, N-methylimidazole, 1-(3-aminopropyl) imidazole, 2-[2-[2-(dimethylamino)ethoxy]ethyl-methylamino]ethanol, N-methyl dicyclohexylamine, 3-{[3-(dimethylamino)propyl]methylamino}propanol, tris (dimethyl aminopropyl)amine, 2-{[3-(dimethylamino)propyl]methylamino}ethanol, N,N,N′,N′-tetramethyl-hexamethylene diamine, N,N,N′,N′-tetramethylethylenediamine, 2,4,6-tris(dimethylaminomethyl)phenol, 1,3,5-tris(dimethylaminopropyl)-hexahydrotriazine, N,N-dimethylbenzylamine, 1,8 diaza bicyclo 5,4,0 undecene 7, N-methyl-N′-(2-dimethylamino) ethyl-piperazine, N,N′-bis[3-(dimethylamino)propyl]urea, N-[3-(dimethylamino)propyl]urea, N,N,N′,N′-tetrakis(2-hydroxypropyl)ethylenediamine, and N,N,N′,N′-tetrakis(2-hydroxyethyl)ethylenediamine.

Preferred amines include alkyl amines, such as bis(2-dimethylaminoethyl)ether, N,N-dimethylaminopropylamine, N,N-dimethylcyclohexylamine, N,N,N′,N′,N″-pentamethyldiethylenetriamine, triethylenediamine, ethanol amines, such as diethanolamine, 2(2-dimethylaminoethoxy)ethanol, N-[2-(dimethylamino)ethyl]-N-methylethanolamine, dimethylethanolamine, or other amines such as 3-dimethylamino-N,N-dimethylpropionamide and N-ethylmorpholine, triethanolamine, 2-dimethylaminoethanol, N,N-dimethylaminopropylamine, diethanolamine, trimethylamine, triethylenediamine, bis(2-dimethylaminoethyl)ether.

A preferred composition according to the invention comprises one or more compounds according to the invention, which further comprises at least one conventional polyurethane formation catalyst, preferably at least one conventional polyurethane foam formation gel catalyst as described before.

Another preferred composition comprising one or more compounds according to the invention, which further comprises at least one carboxylic acid. In a preferred embodiment the composition according to the invention comprises at least one carboxylic acid, such as those described in U.S. Pat. No. 6,387,972 B1. Preferably the carboxylic acids are selected from the group consisting of monocarboxylic acid compounds, such as benzoic acid, polycarboxylic acid compounds, such as dicarboxylic acid compounds, such as oxalic acid, malonic acid, succinic acid, glutaric acid, adipic acid, azelaic acid, sebacic acid, and hydroxyl-functional carboxylic acid compounds, in particular, salicylic acid, citric acid. In a particularly preferred embodiment, the composition comprises at least one carboxylic acid selected from the group consisting of salicylic acid, benzoic acid, oxalic acid, malonic acid, succinic acid, glutaric acid, adipic acid, azelaic acid, sebacic acid, and citric acid.

The compounds or compositions according to the invention are preferably used as a catalyst, in particular for catalyzing the reaction of at least one isocyanate compound with at least one isocyanate-reactive compound, that is as a catalyst for the manufacture of polyisocyanate polyaddition products. Such polyisocyanate polyaddition products have in particular one or more functional groups consisting of the group selected from urethane groups and urea groups. The compounds or compositions according to the invention are preferably used as a catalyst, for the manufacture of polyurethanes, in particular polyurethane foams, most preferably as a blowing catalyst for the manufacture of polyurethane foams, which specifically catalyzes the blowing reaction of water with the isocyanates resulting in the generation of CO₂ gas which acts as a blowing agent.

The present invention therefore relates also to a catalyst comprising the compounds or compositions according to the invention, in particular, to a catalyst composition comprising the compounds of the invention and one more additional catalyst each for the manufacture of polyisocyanate polyaddition products.

The present invention accordingly also relates to a process for the manufacture of an isocyanate addition product comprising the reaction of an isocyanate compound in particular of a polyisocyanate compound with an isocyanate-reactive compound in the presence of the compounds or compositions according to any of the invention. Such process for the manufacture of an isocyanate addition product comprises in particular reacting an isocyanate compound preferably a polyisocyanate compound with an isocyanate-reactive compound in the presence of the compounds or compositions according to the invention in the presence of water. In the process for the manufacture of an isocyanate addition product using the compounds or compositions according to the invention as a catalyst the isocyanate is preferably a polyisocyanate and the isocyanate-reactive compound is preferably a polyol, and the process is for producing a polyurethane, in particular a polyurethane foam.

In the process for the manufacture of an isocyanate addition product according to the invention the isocyanate addition product is preferably a polyurethane, more preferably a polyurethane foam, selected from cellular or non-cellular polyurethanes, and preferably the process optionally comprises a blowing agent, more preferably water.

The process for the manufacture of an isocyanate addition product according to the invention is preferably for producing a polyurethane, and the process optionally comprises the addition of a surfactant, a fire retardant, a chain extender, a cross-linking agent, an adhesion promoter, an anti-static additive, a hydrolysis stabilizer, a UV stabilizer, a lubricant, an anti-microbial agent, or a combination of two or more thereof.

In the process for the manufacture of an isocyanate addition product according to the invention the compounds or compositions according to the invention are present in an amount of about 0.005 wt-% to about 5 wt-% based on the total weight of the total composition including all components.

The present invention also relates to an isocyanate addition product forming a foam obtainable from the process of the manufacture of an isocyanate addition product of the invention. Particularly preferred isocyanate addition products forming a foam can be selected for example from the group consisting of slabstock, molded foams, flexible foams, rigid foams, semi-rigid foams, spray foams, thermoformable foams, microcellular foams, footwear foams, open-cell foams, closed-cell foams, adhesives.

The process for the manufacture of polyurethanes using the compounds or compositions according to the invention as a catalyst is described in more detail in the following.

The term “polyurethane” as utilized herein refers to the reaction product of an isocyanate containing two or more isocyanate groups with compounds containing two or more active hydrogens, e.g. polyols (polyether polyols, polyester polyols, copolymer polyols also known as graft polyols) and/or primary and secondary amine terminated polymer known as polyamines. These reaction products are generally known to those skilled in the art as polyurethanes and/or polyureas. The reaction in forming cellular and non-cellular foams optionally includes a blowing agent. In the production of a polyurethane foam, the reaction includes a blowing agent and other optional components such as surfactants, fire retardants, chain extenders, cross-linking agents, adhesion promoters, anti-static additives, hydrolysis and UV stabilizers, lubricants, anti-microbial agents, catalysts and/or other application specific additives can be used for production of compact or cellular polyurethane materials [The polyurethanes book, Editors David Randall and Steve Lee, John Willey & Sons, L T D, 2002]. The present catalyst materials of the invention are especially suitable for making flexible, semi-flexible, and rigid foams using the one-shot foaming, the quasi-pre-polymer and the pre-polymer processes. The polyurethane manufacturing process of the present invention typically involves the reaction of, e.g. a polyol, generally a polyol having a hydroxyl number from about 10 to about 700, an organic polyisocyanate, a blowing agent and optional additives known to those skilled in the art and one or more catalysts, at least one of which is chosen from the subject tertiary amine compound. As the blowing agent and optional additives, flexible and semi-flexible foam formulations (hereinafter referred to simply as flexible foams) also generally include, e.g. water, organic low boiling auxiliary blowing agent or an optional non-reacting gas, silicone surfactants, optional catalysts other than the catalysts according to the invention, and optional cross-linker(s). Rigid foam formulations often contain both a low boiling organic material and water for blowing. The “one-shot foam process” for making polyurethane foam is a one-step process in which all of the ingredients necessary (or desired) for producing the foamed polyurethane product including the polyisocyanate, the organic polyol, water, catalysts (of the invention and other than the catalysts according to the invention), surfactant(s), optional blowing agents and the like are efficiently mixed, poured onto a moving conveyor or into a mold of a suitable configuration and cured [Chemistry and Technology of Polyols for Polyurethanes, by Mihail Ionescu, Rapra Technology LTD. (2005)]. The one-shot process is to be contrasted with the prepolymer and quasi-prepolymer processes [Flexible polyurethane foams, by Ron Herrington and Kathy Hock, Dow Plastics, 1997]. In the prepolymer process, most prepolymers in use today are isocyanate-tipped. A strict prepolymer is formed when just enough polyisocyanate is added to react with all hydroxyl sites available. If there is an excess or residual isocyanate monomer present, the product is called a quasi-prepolymer. A prepolymer or a quasi-prepolymer is first prepared in the absence of any foam-generating constituents. In a second step, the high molecular weight polyurethanes materials are formed by the reaction of a prepolymer with water and/or chain extender such as: ethylene glycol, diethylene glycol, 1,4-butane diol or a diamine in the presence of catalyst.

The catalyst compounds of the invention and the compositions thereof may be used as a sole catalyst or in combination with one or more additional catalysts for the formation of polyisocyanate addition products such as tertiary amine catalysts as described above.

Furthermore, the catalyst composition of the invention may comprise two or more different compounds according to the invention as described above. The catalyst compounds of the invention or the compositions thereof may be present in the reactive mixture for the formation of polyurethanes including all required components in an amount of from about 0.005% to about 5%; preferably about 0.01% to about 3.0%; or more preferably about 0.03% to about 1.00% the total weight of the reactive compositions. Other catalysts useful for producing polyurethane foams include, for example, tertiary amines such as the alkyl amines described above, organometallic catalysts, e.g. organotin catalysts, metal salt catalysts, e.g. alkali metal or alkaline earth metal carboxylate catalysts, other delayed action catalysts, or other known polyurethane catalysts. Organometallic catalysts or metal salt catalysts also can be, and often are, used in polyurethane foam formulations. For example, for flexible slabstock foams, the generally preferred metal salt and organometallic catalysts are stannous octoate and dibutyltin dilaurate respectively. For flexible molded foams, exemplary organometallic catalysts are dibutyltin dilaurate and dibutyltin dialkylmercaptide. For rigid foams exemplary metal salt and organometallic catalysts are potassium acetate, potassium octoate and dibutyltin dilaurate, respectively. Metal salt or organometallic catalysts normally are used in small amounts in polyurethane formulations, typically from about 0.001 part per hundred parts (pphp) to about 0.5 phpp based on the total weight of the composition.

Polyols which are useful in the process of the invention for making a polyurethane, particularly via the one-shot foaming procedure, are any of the types presently employed in the art for the preparation of flexible slabstock foams, flexible molded foams, semi-flexible foams, and rigid foams. Such polyols are typically liquids at ambient temperatures and pressures and include polyether polyols and polyester polyols having hydroxyl numbers in the range of from about 15 to about 700. The hydroxyl numbers are preferably between about 20 to about 60 for flexible foams, between about 100 to about 300 for semi-flexible foams and between about 250 to about 700 for rigid foams.

For flexible foams the preferred functionality, i.e. the average number of hydroxyl groups per molecule of polyol, of the polyols is about 2 to about 4 and most preferably about 2.3 to about 3.5. For rigid foams, the preferred functionality is about 2 to about 8 and most preferably about 3 to about 5.

Of the polyamines different from the compounds according to the invention, which are useful in the process of the invention for making a polyurethane, diamines such as, e.g., piperazine, 2,5-dimethylpiperazine, bis(4-aminophenyl)ether, 1,3-phenylenediamine and hexamethylenediamine are preferred.

Polyfunctional isocyanate-reactive compounds which can be used in the process for manufacturing the polyurethanes and/or polyureas in the presence of the catalyst composition of the invention, alone or in admixture as copolymers, include for example any of the following non-limiting classes of polyols:

(a) polyether polyols derived from the reaction of polyhydroxyalkanes with one or more alkylene oxides, e.g. ethylene oxide, propylene oxide, etc.;

(b) polyether polyols derived from the reaction of high-functionality alcohols, sugar alcohols, saccharides and/or high functionality amines, if desired in admixture with low-functionality alcohols and/or amines with alkylene oxides, e.g. ethylene oxide, propylene oxide, etc.;

(c) polyether polyols derived from the reaction of phosphorus and polyphosphorous acids with alkylene oxides, e.g. ethylene oxide, propylene oxide, etc.,

(d) polyether polyols derived from the reaction of polyaromatic alcohols with alkylene oxides, e.g. ethylene oxide, propylene oxide, etc.;

(e) polyether polyols derived from the reaction of ring-opening polymerization of tetrahydrofurane;

(f) polyether polyols derived from the reaction of ammonia and/or an amine with alkylene oxides, e.g. ethylene oxide, propylene oxide, etc.;

(g) polyester polyols derived from the reaction of a polyfunctional initiator, e.g. a diol, with a hydroxycarboxylic acid or lactone thereof, e.g. hydroxylcaproic acid or ε-caprolactone;

(h) polyoxamate polyols derived from the reaction of an oxalate ester and a diamine, e.g. hydrazine, ethylenediamine, etc. directly in a polyether polyol;

(i) polyurea polyols derived from the reaction of a diisocyanate and a diamine, e.g. hydrazine, ethylenediamine, etc. directly in a polyether polyol.

For flexible foams, preferred types of alkylene oxide adducts of polyhydroxyalkanes are the ethylene oxide and propylene oxide adducts of aliphatic triols such as glycerol, trimethylol propane, etc. For rigid foams, the preferred class of alkylene oxide adducts are the ethylene oxide and propylene oxide adducts of ammonia, toluene diamine, sucrose, and phenol-formaldehyde-amine resins (Mannich bases).

Grafted or polymer polyols are used extensively in the production of flexible foams and are, along with standard polyols, one of the preferred class of polyols useful in the process of this invention. Polymer polyols are polyols that contain a stable dispersion of a polymer, for example in the polyols a) to e) above and more preferably the polyols of type a). Other polymer polyols useful in the process of this invention are polyurea polyols and polyoxamate polyols.

The polyisocyanates that are useful in the polyurethane foam formation process of this invention are organic compounds that contain at least two isocyanate groups and generally will be any of the known aromatic or aliphatic polyisocyanates. Suitable organic polyisocyanates include, for example, the hydrocarbon diisocyanates, (e.g. the alkylenediisocyanates and the arylene diisocyanates), such as methylene diphenyl diisocyanate (MDI) and 2,4- and 2,6-toluene diisocyanate (TDI), as well as known triisocyanates and polymethylene poly(phenylene isocyanates) also known as polymeric or crude MDI. For flexible and semi-flexible foams, the preferred isocyanates generally are, e.g. mixtures of 2,4-toluene diisocyanate and 2,6-toluene diisocyanate (TDI) in proportions by weight of about 80% and about 20% respectively and also about 65% and about 35% respectively based on the total weight of the composition of TDI; mixtures of TDI and polymeric MDI, preferably in the proportion by weight of about 80% TDI and about 20% of crude polymeric MDI to about 50% TDI and about 50% crude polymeric MDI based on the total weight of the mixture composition; and all polyisocyanates of the MDI type. For rigid foams, the preferred isocyanates are, e.g. polyisocyanates of the MDI type and preferably crude polymeric MDI.

The amount of polyisocyanate included in the foam formulations used relative to the amount of other materials in the formulations is described in terms of “Isocyanate Index”. “Isocyanate Index” means the actual amount of polyisocyanate used divided by the theoretically required stoichiometric amount of polyisocyanate required to react with all the active hydrogen in the reaction mixture multiplied by one hundred (100) [see Oertel, Polyurethane Handbook, Hanser Publishers, New York, N.Y. (1985)]. The Isocyanate Indices in the reaction mixtures used in the process of this invention generally are between 60 and 140. More usually, the Isocyanate Index is: for flexible TDI foams, typically between 85 and 120; for molded TDI foams, normally between 90 and 105; for molded MDI foams, most often between 70 and 90; and for rigid MDI foams, generally between 90 and 130. Some examples of polyisocyanurate rigid foams are produced at Isocyanate Indices as high as 250-400.

Water is preferably used as a reactive blowing agent in both flexible and rigid foams in the poly urethane formation reaction according to the invention which uses the inventive compounds as a catalyst. In the production of flexible slabstock foams, water generally can be used in concentrations of, e.g. between 2 to 6.5 parts per hundred parts (pphp) of polyol blend, and more often between 3.5 to 5.5 pphp of polyol blend. Water levels for TDI molded foams normally range, e.g., from 3 to 4.5 pphp of polyol blend. For MDI molded foam, the water level, for example, is more normally between 2.5 and 5 pphp. Water levels for rigid foam, for example, range from 0.5 to 5 pphp, and more often from 0.5 to 2 pphp of polyol blend. Physical blowing agents such as blowing agents based on volatile hydrocarbons or halogenated hydrocarbons and other non-reacting gases can also be used in the production of polyurethane foams in accordance with the present invention. A significant proportion of the rigid insulation foam produced is blown with volatile hydrocarbons or halogenated hydrocarbons and the preferred blowing agents are the hydrochlorofluorocarbons (HCFC) and the volatile hydrocarbons pentane and cyclopentane. In the production of flexible slabstock foams, water is the main blowing agent; however, other blowing agents can be used as auxiliary blowing agents. For flexible slabstock foams, the preferred auxiliary blowing agents are carbon dioxide and dichloromethane (methylene chloride). Other blowing agents may also be used such as, e.g. the chlorofluorocarbon (CFC) and the trichloromonofluoromethane (CFC-11).

Flexible molded foams typically do not use an inert, auxiliary blowing agent, and in any event incorporate less auxiliary blowing agents than slabstock foams. However, there is a great interest in the use of carbon dioxide in some molded technology. MDI molded foams in Asia and in some developing countries use methylene chloride, CFC-11 and other blowing agents. The quantity of blowing agent varies according to the desired foam density and foam hardness as recognized by those skilled in the art. When used, the amount of hydrocarbon-type blowing agent varies from, e.g. trace amounts to up to about 50 parts per hundred parts (pphp) of polyol blend and C02 varies from, e.g. about 1 to about 10 pphp of polyol blend.

Crosslinkers also may be used in the production of polyurethane foams. Crosslinkers are typically small molecules; usually less than 350 molecular weight, which contain active hydrogens for reaction with the isocyanate. The functionality of a crosslinker is greater than 3 and preferably between 3 and 5. The amount of crosslinker used can vary between about 0.1 pphp and about 20 pphp based on polyol blend and the amount used is adjusted to achieve the required foam stabilization or foam hardness. Examples of crosslinkers include glycerine, diethanolamine, triethanolamine and tetrahydroxyethylethylenediamine.

Silicone surfactants that may be used in the process of this invention include, e.g. “hydrolysable” polysiloxane-polyoxyalkylene block copolymers, “non-hydrolysable” polysiloxane-polyoxyalkylene block copolymers, cyanoalkylpolysiloxanes, alkylpolysiloxanes, and polydimethylsiloxane oils. The type of silicone surfactants used and the amount required depend on the type of foam produced as recognized by those skilled in the art. Silicone surfactants can be used as such or dissolved in solvents such as glycols. For flexible slabstock foams, the reaction mixture usually contains from about 0.1 to about 6 pphp of silicone surfactant, and more often from about 0.7 to about 2.5 pphp. For flexible molded foam the reaction mixture usually contains about 0.1 to about 5 pphp of silicone surfactant, and more often about 0.5 to about 2.5 pphp. For rigid foams, the reaction mixture usually contains about 0.1 to about 5 pphp of silicone surfactant, and more often from about 0.5 to about 3.5 pphp. The surfactant amount used is adjusted to achieve the required foam cell structure and foam stabilization.

Temperatures useful for the production of polyurethanes vary depending on the type of foam and specific process used for production as well understood by those skilled in the art. Flexible slabstock foams are usually produced by mixing the reactants generally at an ambient temperature of between about 20° C. and about 40° C. The conveyor on which the foam rises and cures is essentially at ambient temperature, which temperature can vary significantly depending on the geographical area where the foam is made and the time of year. Flexible molded foams usually are produced by mixing the reactants at temperatures between about 20° C. and about 30° C., and more often between about 20° C. and about 25° C. The mixed starting materials are fed into a mold typically by pouring. The mold preferably is heated to a temperature between about 20° C. and about 70° C., and more often between about 40° C. and about 65° C. Sprayed rigid foam starting materials are mixed and sprayed at ambient temperature. Molded rigid foam starting materials are mixed at a temperature in the range of about 20° C. to about 35° C. The preferred process used for the production of flexible slabstock foams, molded foams, and rigid foams in accordance with the present invention is the “one-shot” process where the starting materials are mixed and reacted in one step.

Accordingly, in an embodiment of the invention it relates to a process for the manufacture of an isocyanate addition product according to any of the previous claims, wherein the isocyanate addition product is a polyurethane, preferably a polyurethane foam, selected from a cellular or non-cellular polyurethane, and the process optionally comprises a blowing agent. In such process optionally comprises the addition of a surfactant, a fire retardant, a chain extender, a cross-linking agent, an adhesion promoter, an anti-static additive, a hydrolysis stabilizer, a UV stabilizer, a lubricant, an anti-microbial agent, or any other common auxiliary additive used in the production of polyurethane, or a combination of two or more thereof. Accordingly, in an embodiment of the invention it also relates to an isocyanate addition product forming a foam formed from the process of the manufacture of an isocyanate addition product as described before, which uses the catalyst composition of the invention. Such isocyanate addition product forming a foam is for example selected from the group consisting of slabstock, molded foams, flexible foams, rigid foams, semi-rigid foams, spray foams, thermoformable foams, footwear foams, open-cell foams, closed-cell foams and adhesives.

While the scope of the present invention is defined by the appended claims, the following examples illustrate certain aspects of the invention and, more particularly, describe methods for evaluation. The examples are presented for illustrative purposes and are not to be construed as limitations on the present invention.

### EXAMPLES

Catalyst Formation Examples

First an 80 weight % of aqueous solution of C1 from U.S. Pat. No. 6,423,756B1, (C1 is the reaction product of dimethylaminoethoxyethanol and isophorone diisocyanate) was prepared and further used as amine catalyst with predominantly gel characteristics. The 80% aqueous solution of C1 is named as C1.1.

### Inventive Catalyst 1 (or IC1) [Reaction Product of 2 Mol of N,N,N′-trimethyl-N′-(2-hydroxyethyl)bis(2-aminoethyl) ether with 1 mol of isophorone diisocyanate]

Then, a four naked 250 mL round bottom flask was equipped with a thermometer, mechanical stirrer and reflux condenser. The flask was flushed with dry nitrogen. Under nitrogen atmosphere N,N,N′-trimethyl-N′-(2-hydroxyethyl)bis(2-aminoethyl) ether (96.09 g, 0.505 mol) was charged into the flask. Isophorone diisocyanate (55.58 g, 0.25 mmol) was added over 30 minutes while vigorously stirring the reaction mixture and by keeping the temperature of the reaction mixture bellow 80° C. After the complete addition of isophorone diisocyanate the reaction mixture was heated at 75° C. for 2.5 hours to provide clear, viscous product. 43.32 g of the product. ¹³C and ¹H NMR data confirmed the formation of Inventive catalyst 1 (IC1, as shown below as reaction product). 43.32 g of IC1 was dissolved in 10.83 g water to obtain 80 weight % aqueous solution IC1.1, which was used for polyurethane foam production. Furthermore, 71.70 g of IC1 was dissolved in 10.43 g dipropylene glycol to obtain IC1.2 which was used for polyurethane foaming reactions.

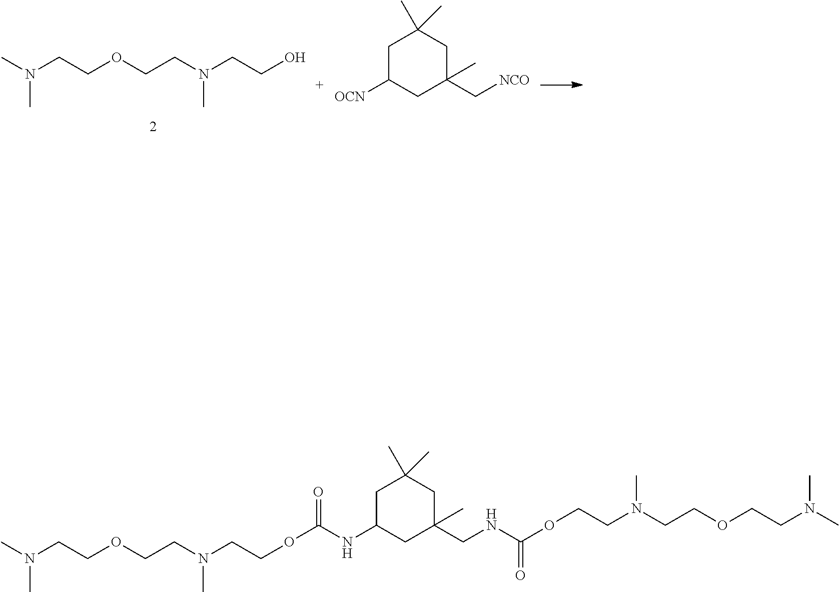

### Inventive Catalyst 2 (or IC2) [Reaction Product of 2 Mol of 2-{2-[(3-aminopropyl)(methyl) amino]ethoxy}ethyl)dimethylamine (or N′-[2-[2-(dimethylamino)ethoxy]ethyl]-N′-methyl-propane-1,3-diamine) with 1 mol of isophorone diisocyanate]

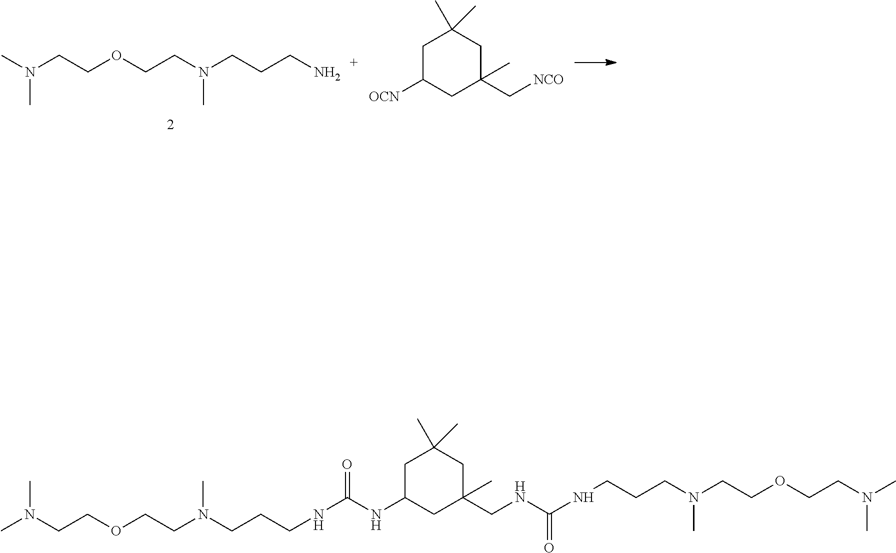

Into a 10 mL glass vial equipped with a magnetic stirrer 2.03 g (10 mmol) 2-{2-[(3-aminopropyl)(methyl)amino]ethoxy}ethyl)dimethylamine was added under nitrogen atmosphere and the vial was sealed with a septum cap. 1.11 g isophorone diisocyanate (5.0 mmol) was added dropwise while vigorously stirring the reaction mixture. The mixture was vigorously stirred for ˜5 minutes and the vial was placed into the heating block at 75° C. After 2 hours the vial was taken out from the heating block and cooled down to room temperature. A transparent glassy, high viscous mass was obtained. ¹³C and ¹H NMR data confirmed the formation of Inventive catalyst 2 (IC2, shown as reaction product in the scheme above)).

Foaming Experiments:

The polyurethane foams were prepared according to the following procedure. A premix P1 of 4950.00 g reactive polyether polyol (Hyperlite® (or HP) 1629; hydroxyl number of 29.5-33.5 mg KOH/g), 49.50 g EO-rich cell opener (Voranol™ CP 1421; hydroxyl number of 33 mg KOH/g), 32.67 g 90 wt-% aqueous solution of diethanolamine (DEOA 90% in water), 29.70 g silicone stabilizer (Niax® Silicone L-3639S), 148.50 g water and 39.60 g predominantly gel catalyst C1.1 (for polyurethanes foams presented in Table 1) was prepared by mixing the mixture thoroughly in a plastic bucket for 20 minutes using propeller stirrer with ring at 800 rpm. From the premix, single batches each of 291.67 g were weighed to an appropriate mixing plastic container, the additional water amounts and corresponding catalysts (for instance C1.1, IC1.1) were added to obtain adjusted final polyol blends according to proportions given in Table 1.

For foam systems presented in Table 2 the premix P2 was prepared without addition of water and any catalyst by mixing the mixture thoroughly in a plastic bucket for 20 minutes using propeller stirrer with ring at 800 rpm. For those foam compositions after preparing the premix, single batches each of 281.22 g were weighed to an appropriate mixing plastic container.

The required water amounts and corresponding catalysts (for instance C1.1, IC1.1) were added to obtain the final polyol blends according to proportions given in Table 2.

To produce a foam pad the polyol blend was mixed thoroughly in the plastic container for 30 seconds using propeller stirrer with ring at 3000 rpm. Defined amount of Suprasec 2447 isocyanate (MDI, with NCO content of 32.6%) was added according to proportions given in Table 1 or 2 and the reactive mixture was mixed for 4-6 seconds. The reactive mixture was immediately poured into a 30×30×10 cm aluminum mold and the mold was immediately closed and clamped. The mold lid had four vent openings with a diameter of 0.4 mm at the four corners. The mold temperature was controlled at 55° C. via a hot water circulating thermostat. Release agent Chem-Trend® PU-1705M was used to coat the mold. Foams were demolded after 4 minutes. The processing and physical characteristics of the foam were evaluated as follows:

| Physical | |
|---|---|
| Characteristic | Test Method |
| Density | ASTM D 3574-05 |
| Exit Time | Exit time is the time elapsed, in seconds, from the addition of the isocyanate to |
| | the reaction mixture to the first appearance of foam extrusion from the four |
| | vents of the mold. The exit time is an appropriate relative measure of |
| | generation of the blowing agent CO₂ resulting from the reaction of water and |
| | isocyanate during foaming of water blown polyurethane systems. The lower |
| | the exit time value, the higher the blowing efficiency of the system. |
| Force-to-Crush | ASTM 3574-05. Force-to-crush (FTC) is the peak force required to deflect a |
| FTC, N | foam pad with the standard 323 cm² (50 sq. in.) indentor, 1 minute after |
| | demold, to 50% of its original thickness. It is measured with a load-testing |
| | machine using the same setup as that used for measuring foam hardness. A |
| | load tester crosshead speed of 50.8 cm/minute is used. The FTC value is a |
| | good relative measure of the degree of cell openness characteristic of a foam, |
| | i.e. the lower the value, the more open the foam. |
| Hot ILD | ASTM 3574-05. The indentation load deflection (hot ILD) is measured on the |
| | same pad used for the FTC measurement 3 minutes after demold. Following |
| | the FTC measurement, the foam pad is completely crushed by a mechanical |
| | crusher before the measurement of ILD at 50% compression is taken. The hot |
| | ILD value is a good relative measure of the curing degree of a foam 3 minutes |
| | after demold. The higher the hot ILD value, the higher the curing degree of the |
| | foam. |
| ILD | ASTM 3574-05. The indentation load deflection (ILD) is measured on the same |
| | pad used for the FTC and hot ILD measurements at least 48 hours after |
| | demold. Following the FTC and hot ILD measurements, the foam pad is |
| | completely crushed by a mechanical crusher before the measurement of ILD at |
| | 50% compression is taken. The ILD value is a good relative measure of the |
| | curing degree of a foam at least 48 hours after demold. The higher the ILD |
| | value, the higher the curing degree of the foam. |

The summary table of the PU foam composition and PU foam properties is shown in the following Table 1 for reactive mixture 1 to 4 (the composition of the chemical components is given in parts per weight or pbw)

TABLE 1

| | Foam composition | | | |
|---|---|---|---|---|
| | 1 | 2 | 3 | 4 |
| HP-1629 | 100.00 | | | |
| CP-1421 | 1.00 | | | |
| DEOA (90% in water) | 0.66 | | | |
| Niax Silicone L-3639S | 0.60 | | | |
| Inventive catalyst solution IC1.1 | — | | 0.25 | 0.75 |
| Catalyst solution C1.1 | 1.05 | 1.55 | 0.80 | |
| Water added | 3.75 | 3.65 | 3.75 | 3.65 |
| Water total | 4.03 | | | |
| MDI Suprasec 2447 | 67.4 | 67.1 | 67.1 | 67.1 |
| Exit time, sec | 78 | 52 | 60 | 40 |
| FTC, N | 379 | 1233 | 409 | 559 |
| hot ILD, N | 288 | 348 | 334 | 399 |
| ILD, N | 833 | 765 | 829 | 801 |
| Density of the pad, kg/m³ | 46 | 46 | 46 | 45 |

It was found that the addition of the Inventive Catalyst solution IC1.1 to the catalyst solution C1.1 significantly improves the blowing efficiency of the catalyst blend. Thus, the exit time of the reactive mixture 1 is 78 seconds, whereas the exit time of the reactive mixture 3 is 60 seconds although the total weight amounts of active catalysts are the same (0.80+0.25=1.05 pbw) in those comparative experiments 1 and 3. In the same manner the comparison of exit time from the experiment 2 (52 seconds) with experiment 4 clearly demonstrates the higher blowing efficiency of the Inventive Catalyst solution IC1.1. In addition, it was found that ILD values for PU foams prepared by using Inventive Catalyst solution IC1.1 tend to be beneficially higher compared to PU foams made by using only the state-of-the-art catalyst solution C1.1. This tendency is demonstrated by comparison of ILD values of foams 2 and 4 made at higher use level of catalysts (0.80+0.75=1.55 pbw). In particularly, the catalyst composition of 0.80 pbw C1.1 and 0.75 pbw of IC1.1 (reactive mixture 4) provided PU foams with higher ILD values compared to the PU foams obtained from the reactive mixture 2 where C1.1 was used as sole catalyst at a use level of 1.55 pbw.

The summary of the experiments shown in the following Table 2 presents the comparison where only a single catalyst is used and where the Inventive catalyst in solution IC1.1 is compared with state-of-the-art catalyst in solution C1.1.

TABLE 2

| | Foam composition | | | |
|---|---|---|---|---|
| | A1 | A2 | A3 | A4 |
| HP-1629 | 100.00 | | | |
| CP-1421 | 1.00 | | | |
| DEOA (90% in water) | 0.66 | | | |
| Niax Silicone L-3639S | 0.60 | | | |
| Inventive catalyst IC1.1 | 0.50 | 1.10 | | |
| Comparative catalyst C1.1 | | | 0.50 | 1.10 |
| Water added | 3.86 | 3.74 | 3.86 | 3.74 |
| Water total | 4.03 | | | |
| MDI Suprasec ® 2447 | 67.1 | | | |
| Exit time, sec | 83 | 44 | 143 | 82 |
| FTC, N | 222 | 460 | 107* | 341 |
| hot ILD, N | 193 | 375 | 109* | 292 |
| ILD, N | 818 | 864 | 828* | 828 |
| Density of the pad, kg/m³ | 48 | 47 | 49 | 48 |

*the foam was very soft, sticky and vulnerable after demolding indicating incomplete curing which is apparent also from the lower FTC and hot ILD values. The skin of the foam became wrinkly after demolding. Thus, the ILD values for this foam are not recommended to be used in further argumentation.

It was found that the blowing efficiency of the Inventive catalyst IC1.1 is significantly higher compared to state-of-the-art catalyst C1.1. Thus, the exit time of the reactive mixture A1 catalyzed by IC1.1 is 83 seconds, whereas the exit time of the reactive mixture A3 catalyzed by state-of-the-art catalyst C1.1 is significantly longer and is 143 seconds. Furthermore, in comparison to the PU foam A1, the foam A3 was very soft, sticky and vulnerable after demolding which is apparent from the lower FTC and hot ILD values. The skin of the PU foam A3 became wrinkly after demolding confirming incomplete polymerization. In the same manner the comparison of exit times from the experiment A2 (44 seconds) with experiment A4 clearly demonstrates the better blowing efficiency of the invented catalyst IC1. Furthermore, in addition to faster exit times the beneficial higher hot ILD and ILD values of A2 PU foam compared to A4 PU foam demonstrates the better curing efficiency of the Inventive catalyst IC1.1.

The following polyurethane foams based on TDI were prepared according to the following procedure. A premix P3 of 1425.00 g reactive polyether polyol (Hyperlite® polyol 1629; hydroxyl number of 29.5-33.5 mg KOH/g), 1425.00 g styrene-acrylonitrile (SAN) polymer modified reactive polyether polyol with 43% SAN content (Hyperlite® polyol 1639; hydroxyl number of 20 mg KOH/g), 34.20 g 90 wt-% aqueous solution of diethanolamine (DEOA 90% in water), 28.50 g silicone stabilizer (Niax® Silicone L-3555) and 85.50 g water was prepared by mixing the mixture thoroughly in a plastic bucket for 20 minutes using propeller stirrer with ring at 800 rpm. From the premix P3, single batches each of 315.60 g were weighed to an appropriate mixing plastic container, the additional water amounts and corresponding catalysts in solution (for instance C1.1, IC1.1) were added to obtain final polyol blends according to proportions given in Table 3. To produce a PU foam pad the polyol blend was mixed thoroughly in the plastic container for 30 seconds using propeller stirrer with ring at 3000 rpm. Defined amount of Scuranate T80 isocyanate (TDI, with NCO content of 48.1%) was added according to proportions given in Table 3 and the reactive mixture was mixed for 4-6 seconds. The reactive mixture was immediately poured into a 30×30×10 cm aluminum mold and the mold was immediately closed and clamped. The mold lid had 4 vent openings with a diameter of 0.4 mm at the four corners. The mold temperature was controlled at 65° C. via a hot water circulating thermostat. Release agent Chem-Trend® PU-1705M was used for coating the mold. Foams were demolded after 5 minutes. The processing and physical characteristics of the foam were evaluated as described above.

Table 3 describes reactive mixtures B1 to B4 of the PU foam compositions in pbw and the physical properties of corresponding PU foams.

TABLE 3

| | Foam composition | | | |
|---|---|---|---|---|
| | B1 | B2 | B3 | B4 |
| HP-1629 | 50.00 | | | |
| HP-1639 | 50.00 | | | |
| DEOA (90% in water) | 1.20 | | | |
| Niax Silicone L-3555 | 1.00 | | | |
| Inventive catalyst IC1.1 | 0.375 | 0.625 | | |
| Comparative catalyst | | | 0.375 | 0.625 |
| C1.1 | | | | |
| Water added | 3.66 | 3.61 | 3.66 | 3.61 |
| Water total | 3.86 | | | |
| TDI Scuranate ® T80 | 44.10 | | | |
| Exit time, sec | 49 | 33 | 68 | 53 |
| FTC, N | 140* | 441 | 121* | 467 |
| hot ILD, N | 129* | 166 | 89* | 147 |
| ILD, N | 618 | 552 | 606* | 527 |
| Density of the pad, | 40 | 40 | 41 | 41 |
| kg/m³ | | | | |

*the foam was very soft, sticky and vulnerable after demolding indicating incomplete curing which is apparent also from the lower FTC and hot ILD values. The skin of the foam became wrinkly after demolding. Thus, the ILD values for this foam are not recommended to be used in further argumentation.

It was found that the blowing efficiency of the Inventive catalyst IC1.1 is significantly higher compared to state-of-the-art catalyst C1.1. Thus, the exit time of the reactive mixture B1 catalyzed by IC1.1 is 49 seconds, whereas the exit time of the reactive mixture B3 catalyzed by state-of-the-art catalyst C1.1 is significantly longer and is 68 seconds. Furthermore, in comparison to the foam B1 the foam B3 was very much softer and stickier and more vulnerable after demolding which is apparent from the lower FTC and hot ILD values. The skin of the foam B3 became very wrinkly after demolding confirming incomplete polymerization. In the same manner the comparison of exit times from the experiment B2 (33 seconds) with experiment B4 clearly demonstrates the better blowing efficiency of the invented catalyst. Furthermore, in addition to faster exit times the tendency of beneficial higher hot ILD and ILD values of B2 foams compared to B4 foams demonstrates the better curing efficiency of the Invented catalyst IC1.1.

1. A compound obtained by the reaction of an isocyanate compound with at least one isocyanate-reactive compound of the formula (I):
(R)ₐ—X (I)
wherein
R is selected from R¹ and R², wherein
R¹ is selected from the group consisting of R³, R⁴, R⁵, R⁶, R¹⁴ and R¹⁶, where
R³ is a hydrocarbyl group comprising at least two tertiary amino groups and at least one ether (—O—) group,
R⁴ is a hydrocarbyl group comprising at least one monocyclic heterocyclic group,
R⁵ is a group of the formula: 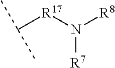
(the dotted line indicates the binding site to X)
wherein R¹⁷ is an aliphatic hydrocarbyl group having at least three carbon atoms, and R⁷ and R⁸ each represent a linear or branched aliphatic hydrocarbyl residue, which optionally may be substituted by one or more tertiary amino groups, and may optionally contain one or more ether (—O—) groups,
R⁶ is a group of the formula: 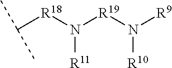
wherein R¹⁸ is an aliphatic hydrocarbyl group having at least two carbon atoms, R¹⁹ is an aliphatic hydrocarbyl group having at least three carbon atoms, and R⁹ to R¹¹ are each independently selected from a linear or branched aliphatic hydrocarbyl residue,
R¹⁴ is a group of the formula: 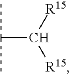
wherein each R¹⁵ independently is selected from a hydrocarbyl group, comprising at least one tertiary amino group, and optionally comprises one or more ether (—O—) groups, and
R¹⁶ is an aromatic group substituted by at least two hydrocarbyl groups, each comprising at least one tertiary amino group,
R² is selected from a hydrocarbyl group or hydrogen,
a is 2 or 3, and
X is selected from the group consisting of O, S, or N,
with the provisos that the compounds comprise at least one group R¹ and at least one group R being R² being hydrogen and that R¹ can represent only one group R⁵,
or salts thereof, and mixtures thereof.

2. The compound according to claim 1, wherein the isocyanate-reactive compound is selected from the group consisting of:

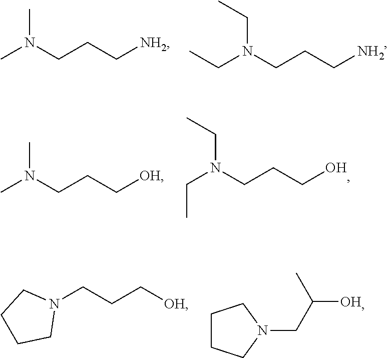

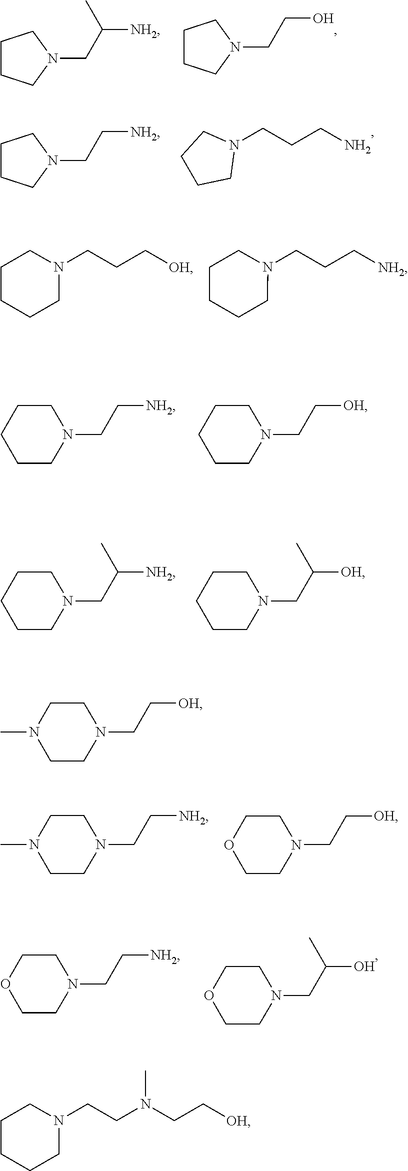

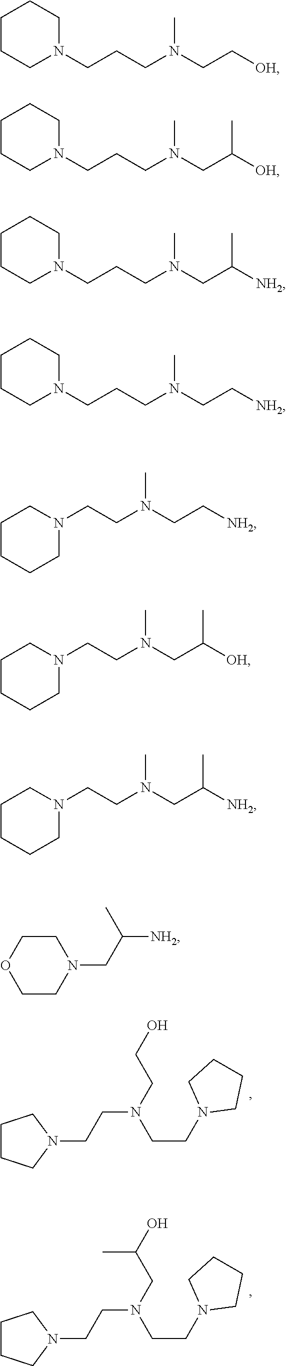

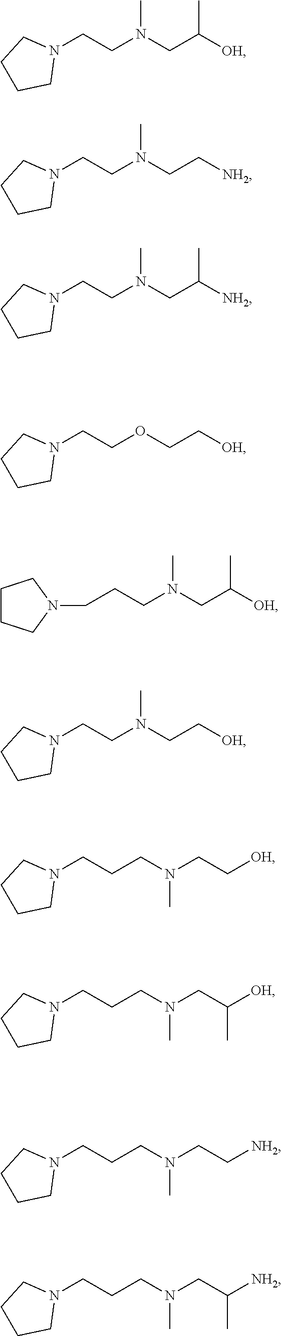

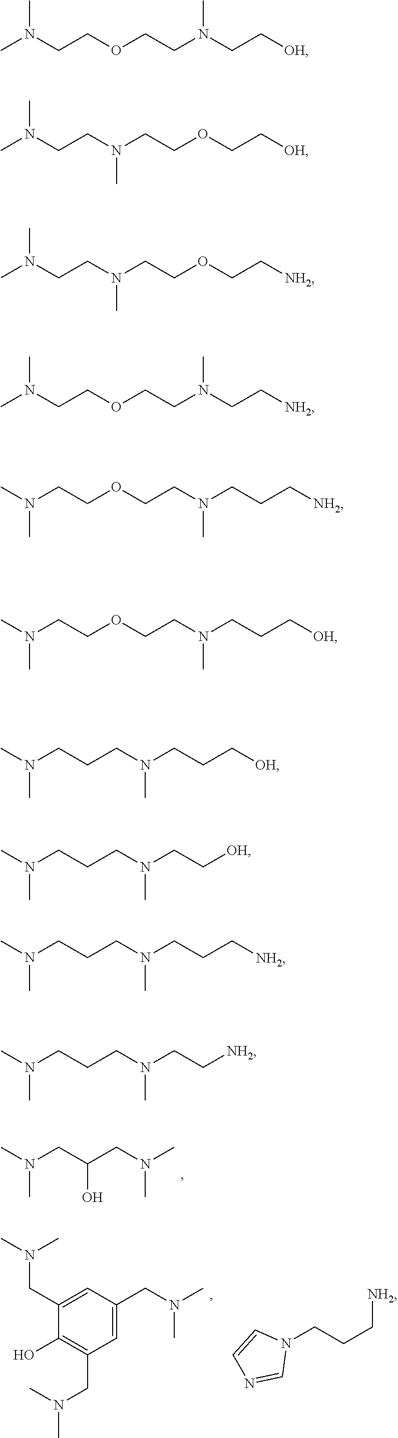

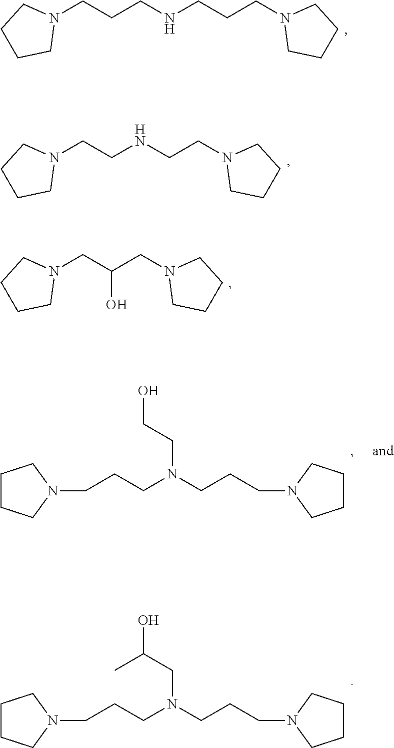 [SMILES: C1CCN(CCCNCCCN2CCCC2)C1 ; C1CCN(CCNCCN2CCCC2)C1 ; OC(CN1CCCC1)CN1CCCC1 ; OCCN(CCCN1CCCC1)CCCN1CCCC1 ; CC(O)CN(CCCN1CCCC1)CCCN1CCCC1]

3. The compound according to claim 1, wherein R¹ in formula (I) of the isocyanate-reactive compounds is selected from the group consisting of R³.

4. The compound according claim 1, wherein R¹ in formula (I) of the isocyanate-reactive compounds is selected from the group consisting of R³ selected from the group consisting of saturated aliphatic hydrocarbyl groups having up to 20 carbon atoms, comprising at least two tertiary amino groups and at least one ether (—O—) group.

5. The compound according to claim 1, wherein R¹ in formula (I) of the isocyanate-reactive compounds is selected from the group consisting of R³ selected from the following formula: 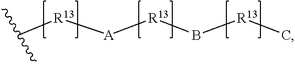
wherein the groups R¹³ are independently selected from a divalent linear, branched or cyclic hydrocarbyl groups, and two of A, B, and C is selected from a tertiary amino group, (—N(R¹²)— for A and/or B, and —N(R¹²)₂ for C, where R¹² is an organic group, and one of A, B, or C is an ether group (for A and B selected from —O— and for C selected from —OR¹², wherein R¹² is as defined before.

6. The compound according to claim 1, wherein R¹ in formula (I) of the isocyanate-reactive compounds is selected from the group consisting of R³ selected from the following formula: 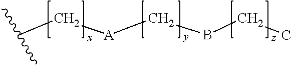
wherein x, y, and z are integers of 2 to 6, and two of A, B, and C represent tertiary amino groups (for A and B selected from —N(R¹²)— and for C selected from —N(R¹²)₂ where R¹² is an organic group) and one of A, B, or C is an ether group (for A and B selected from —O— and for C selected from —OR¹², wherein R¹² is as defined before.

7. The compound according to claim 1, wherein R¹ in formula (I) of the isocyanate-reactive compounds is selected from the group consisting of R³ and where the isocyanate-reactive compounds are selected from the consisting of:

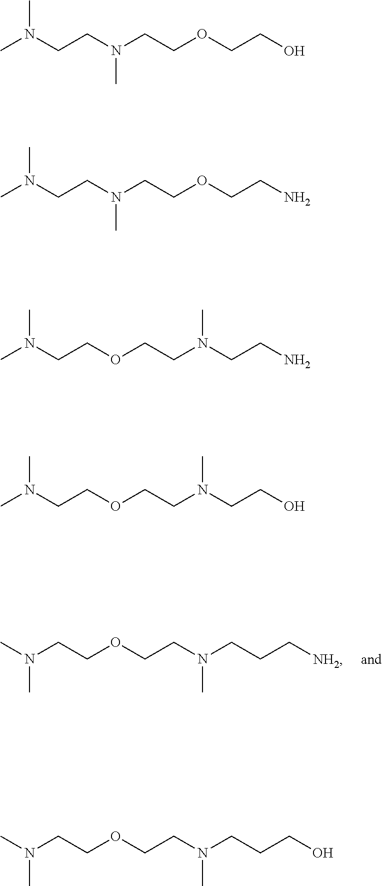

8. The compound according to claim 1, wherein R¹ in formula (I) of the isocyanate-reactive compounds is selected from the group consisting of R³ and where the isocyanate-reactive compounds are selected from the consisting of:

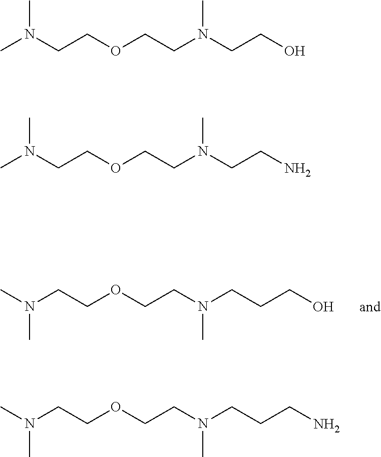

9. The compound according to claim 1, wherein R¹ in formula (I) of the isocyanate-reactive compounds is selected from the group consisting of R⁴.

10. The compound according to claim 1, wherein R¹ in formula (I) of the isocyanate-reactive compounds is selected from the group consisting of R⁴ which is a saturated linear or branched hydrocarbyl group having up to 10 carbon atoms, which may contain up to three heteroatoms, such as N or O, which may be substituted by one or more hydroxy groups, and which hydrocarbyl group is substituted by at least one monocyclic heterocyclic group, selected from saturated or unsaturated or aromatic optionally substituted 5 to 6-membered heterocyclic rings having optionally one or two heteroatoms selected from N, O, and S.

11. The compound according to claim 1, wherein the monocyclic heterocyclic group in R⁴ in formula (I) of the isocyanate-reactive compounds is selected from the group consisting of pyrrolidinyl, piperidyl, 4-alkylpiperazin-1-yl, imidazolyl, and morpholin-4-yl.

12. The compound according to claim 1, wherein R¹ in formula (I) in formula (I) of the isocyanate-reactive compounds is selected from the group consisting of R⁴ and where the isocyanate-reactive compounds are selected from the group consisting of:

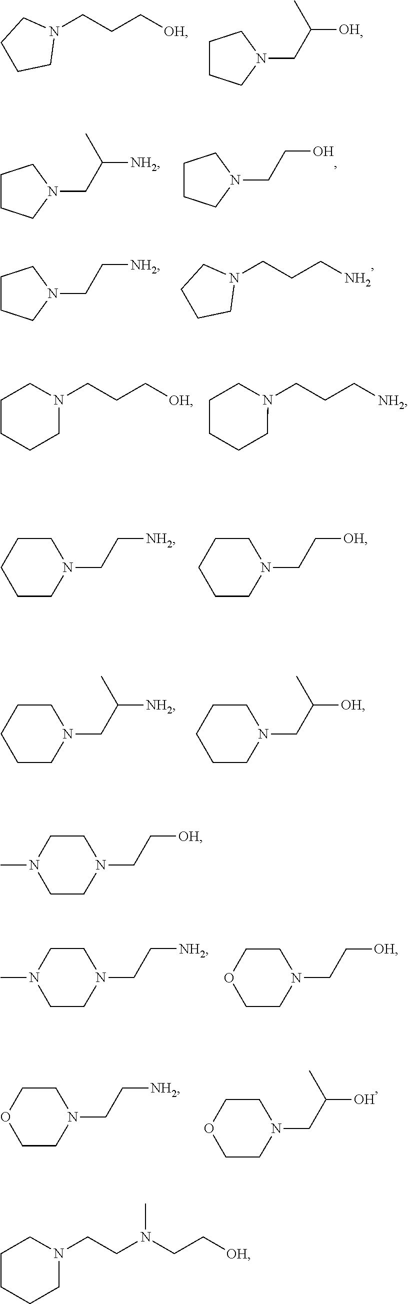

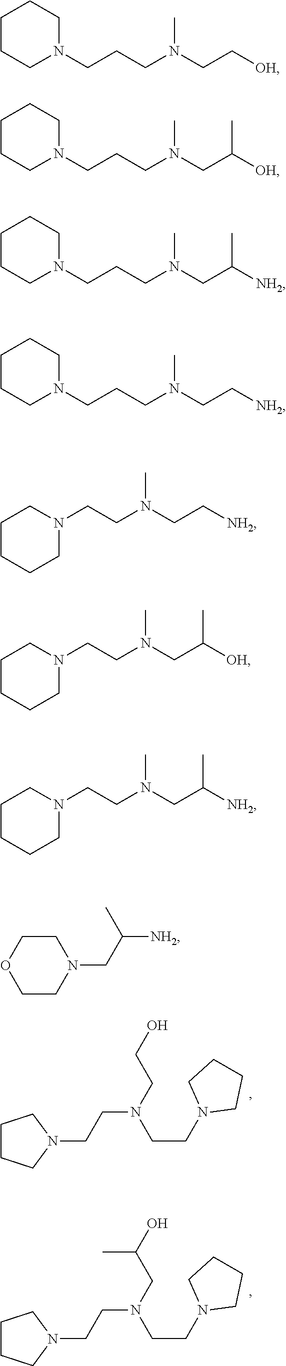

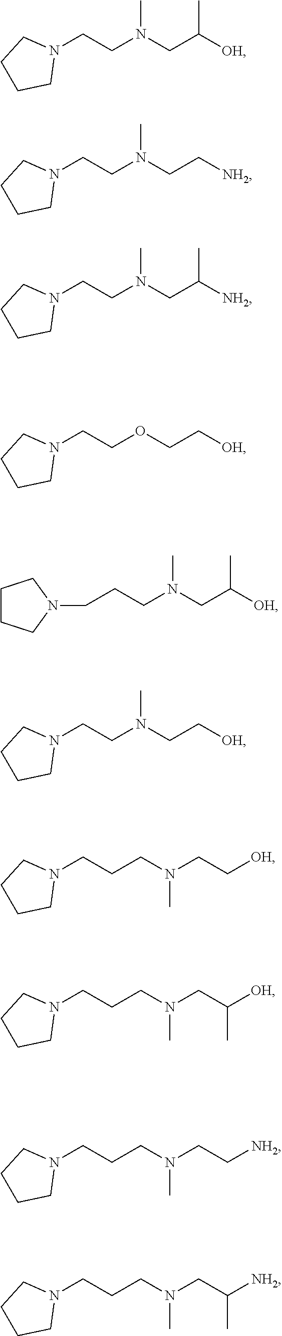

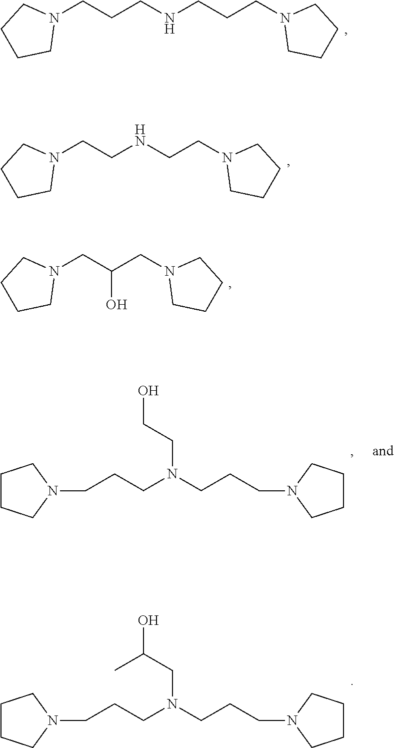 [SMILES: C1CCN(CCCNCCCN2CCCC2)C1 ; C1CCN(CCNCCN2CCCC2)C1 ; OC(CN1CCCC1)CN1CCCC1 ; OCCN(CCCN1CCCC1)CCCN1CCCC1 ; CC(O)CN(CCCN1CCCC1)CCCN1CCCC1]

13. The compound according to claim 1, wherein R¹ in formula (I) in formula (I) of the isocyanate-reactive compounds is selected from the group consisting of R⁵ and R⁶.

14. The compound according to claim 1, wherein R¹ in formula (I) in formula (I) of the isocyanate-reactive compounds is selected from the group consisting of R⁵ and R⁶, wherein
R⁵ is a group of the formula: 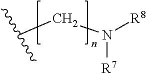
wherein n is an integer of ≥3, and R⁷ and R⁸ each selected from a linear or branched aliphatic hydrocarbyl residue, which optionally may be substituted by one or more tertiary amino groups, and may optionally contain one or more ether (—O—) groups, and
R⁶ is a group of the formula: 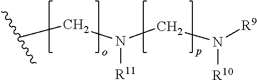
wherein o is an integer of ≥2, p is an integer of ≥3, and R⁹ to R¹¹ each represent a linear or branched aliphatic hydrocarbyl residue.

15. The compound according to claim 1, wherein R¹ in formula (I) in formula (I) of the isocyanate-reactive compounds is selected from the group consisting of
R⁵ is a group of the formula: 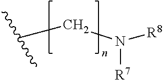
wherein n is an integer of 3 to 6, and R⁷ and R⁸ each represent a linear or branched alkyl group with up to 6 carbon atoms, and
R⁶ is a group of the formula: 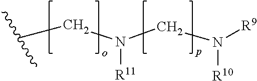
wherein o is an integer of 2 to 6, p is an integer of 3 to 6, and R⁹ to R¹¹ are each selected from a linear or branched alkyl group with up to 6 carbon atoms.

16. The compound according to claim 1, wherein R¹ in formula (I) in formula (I) of the isocyanate-reactive compounds is selected from the group consisting of R⁵ and R⁶ and where the isocyanate-reactive compound is selected from the group consisting of:

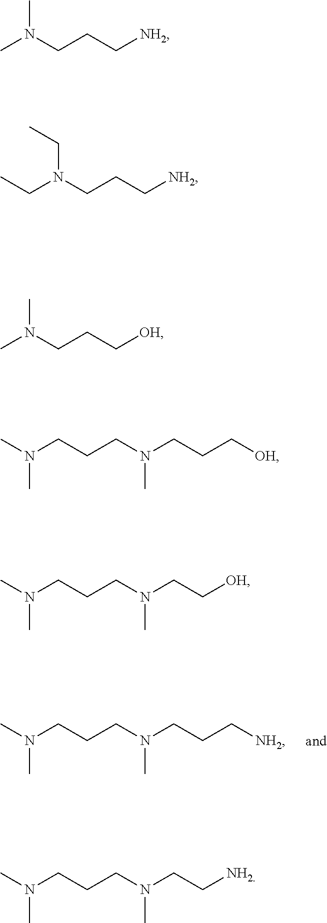

17. The compound according to claim 1, wherein R¹ in formula (I) of the isocyanate-reactive compounds is selected from the group consisting of R¹⁴ or R¹⁶.

18. The compound according to claim 1, wherein R¹ in formula (I) of the isocyanate-reactive compounds is selected from the group consisting of R¹⁴ or R¹⁶ and where the isocyanate-reactive compound is selected from:

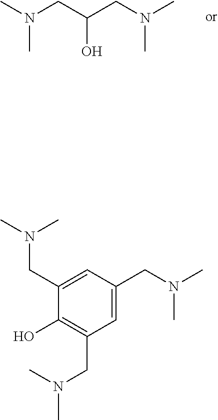

19. The compound according to claim 1, wherein the at least one isocyanate-reactive compound is selected from the group of the formulas (Ia) and (Ib):
R¹—OH (Ia),
R¹—NH—R² (Ib), and
R¹—NH—R¹ (Ic),
wherein R¹ and R² are each as defined above.

20. The compound according to claim 1, wherein the isocyanate compound is selected from mono- and polyisocyanate compounds.

21. The compound according to claim 1, wherein the isocyanate compound is a monoisocyanate.

22. The compound according to claim 1, wherein the isocyanate compound is a monoisocyanate selected from aliphatic or aromatic isocyanates selected from octadecylisocyanate; octylisocyanate; butyl and t-butylisocyanate; cyclohexyl isocyanate; adamantyl isocyanate; ethylisocyanatoacetate; ethoxycarbonylisocyanate; phenylisocyanate; alphamethylbenzyl isocyanate; 2-phenylcyclopropyl isocyanate; 2-ethylphenylisocyanate; benzylisocyanate; meta and para-tolylisocyanate; 2-, 3-, or 4-nitrophenylisocyanates; 2-ethoxyphenyl isocyanate; 3-methoxyphenyl isocyanate; 4-methoxyphenyl isocyanate; ethyl 4-isocyanatobenzoate; 2,6-dimethylphenylisocyanate; 1-naphythylisocyanate; and (naphthyl) ethylisocyanates.

23. The compound according to claim 1, wherein the isocyanate compound is a polyisocyanate.

24. The compound according to claim 1, wherein the isocyanate compound is a polyisocyanate selected from aliphatic or aromatic polyisocyanates selected from the group consisting of isophorone diisocyanate (IPDI); toluene diisocyanate (TDI); diphenylmethane-2,4′-diisocyanate (2,4′-MDI); diphenylmethane-4,4′-diisocyanate (4,4′-MDI); hydrogenated diphenylmethane-4,4′-diisocyanate (H.12 MDI); tetra-methyl xylene diisocyanate (TMXDI); hexamethylene-1,6-diisocyanate (HDI); napthylene-1,5-diisocyanate; 3,3′-dimethoxy-4,4′-biphenyldiisocyanate; 3,3′-dimethyl-4,4′-bimethyl-4,4′-biphenyldiisocyanate; phenylene diisocyanate; 4,4′-biphenyldiisocyanate; trimethylhexamethylene diisocyanate; tetramethylene xylene diisocyanate; 4,4′-methylene-bis (2,6-diethylphenyl isocyanate); 1,12-diisocyanatododecane; 1,5-diisocyanato-2-methylpentane; 1,4-diisocyanatobutane; and cyclohexylene diisocyanate and its isomers or and derivatives thereof; trimethylolpropane trimer of TDI, isocyanurate trimers of TDI, HDI, IPDI; biuret trimers of TDI, HDI, or IPDI; and polyisocyanates, where the isocyanate groups are partially reacted with at least one isocyanate-reactive compound which does not have a group R¹.

25. The compound according to claim 1, wherein the isocyanate compound is a polyisocyanate selected from isophorone diisocyanate (IPDI), hexamethylene diisocyanate (HDI), and derivatives derived from IPDI and/or HDI.

26. The compound according to claim 1, wherein the isocyanate compound is isophorone diisocyanate (IPDI) and R¹ of the isocyanate-reactive compounds of the formula (I) is selected from R³.

27. The compound according to claim 1, wherein the isocyanate groups of the polyisocyanates are completely or partially reacted.

28. The compound according to claim 1, selected from compounds of the formula (II) and (III): 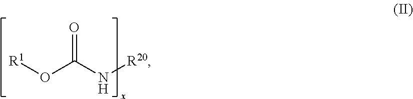
wherein R¹ is as defined above, x is 1 to 6, and R²⁰ is one- to six-valent optionally substituted hydrocarbyl group that optionally contains one or more heteroatoms and which is bound to the nitrogen atom of the urethane group by a carbon atom, 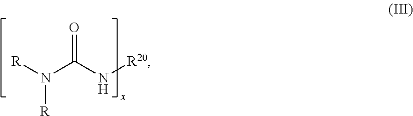
wherein one R is R¹ as defined above, and the other R is selected from R¹ or R² as defined above, and x and R²⁰ are as defined above, wherein R²⁰ is bound to the nitrogen atom of the urea group by a carbon atom.

29. The compound according to claim 1, selected from

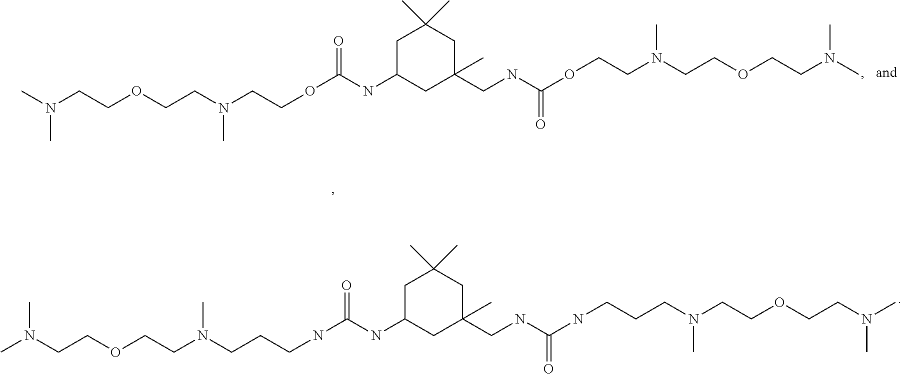

30. A process for the manufacture of the compounds according to claim 1, which process comprises reacting the at least one isocyanate compound and the at least one at least one isocyanate-reactive compound of the formula (I).

31. The process according to claim 30, wherein the reaction is carried out at a temperature of about 20-140° C., optionally in the presence of one or more diluents and one or more catalysts.

32. A composition comprising one or more compounds according to claim 1, which further comprises (i) at least one diluent; and/or (ii) at least one conventional polyurethane formation catalyst; and/or (iii) comprises at least one carboxylic acid selected from the group consisting of monocarboxylic acid compounds, polycarboxylic acid compounds, such as dicarboxylic acid compounds, and hydroxyl-functional carboxylic acid compounds.

33. (canceled)

34. (canceled)

35. The composition according to claim 32, the at least one carboxylic acid is selected from the group consisting of salicyclic acid, benzoic acid, oxalic acid, malonic acid, succinic acid, glutaric acid, adipic acid, azelaic acid, sebacic acid, and citric acid.

36. (canceled)

37. (canceled)

38. (canceled)

39. (canceled)

40. (canceled)

41. (canceled)

42. A catalyst comprising the compounds or compositions according to claim 1.

43. The catalyst according to claim 42, comprising one more additional catalyst for the manufacture of polyisocyanate polyaddition products.

44. A process for the manufacture of an isocyanate addition product comprising reacting an isocyanate compound with an isocyanate-reactive compound in the presence of the compound according to claim 1.

45. A process for the manufacture of an isocyanate addition product comprising reacting an isocyanate compound with an isocyanate-reactive compound in the presence of the compounds according to claim 1 in the presence of water.

46. The process for the manufacture of an isocyanate addition product, according to claim 45, wherein the isocyanate is a polyisocyanate and the isocyanate-reactive compound is a polyol, and the process is for producing a polyurethane.

47. The process for the manufacture of an isocyanate addition product according to claim 46, wherein the isocyanate addition product is a polyurethane selected from cellular or non-cellular polyurethanes, and the process optionally comprises a blowing agent.

48. The process for the manufacture of an isocyanate addition product according to claim 45, wherein the process is for producing a polyurethane, and the process optionally comprises the addition of a surfactant, a fire retardant, a chain extender, a cross-linking agent, an adhesion promoter, an anti-static additive, a hydrolysis stabilizer, a UV stabilizer, a lubricant, an anti-microbial agent, or a combination of two or more thereof.

49. The process for the manufacture of an isocyanate addition product according to claim 45, wherein the compound is present in an amount of about 0.005 wt-% to about 5 wt-% based on the total weight of the total composition including all components.

50. An isocyanate addition product forming a foam obtainable from the process of the manufacture of an isocyanate addition product of claim 45.

51. The isocyanate addition product forming a foam according to claim 50 selected from the group consisting of slabstock, molded foams, flexible foams, rigid foams, semi-rigid foams, spray foams, thermoformable foams, microcellular foams, footwear foams, open-cell foams, closed-cell foams, adhesives.
